(19) United States
(12) Patent Application Publication
(10) Pub. No.: US 2019/0319688 A1
(43) Pub. Date: Oct. 17, 2019

(54) Information Transmission Method, Access Network Device, and Terminal Device

(71) Applicant: Huawei Technologies Co., Ltd., Shenzhen (CN)

(72) Inventors: Xiaodong Sun, Shenzhen (CN); Richard Stirling-Gallacher, Munich (DE); Kai Xu, Shenzhen (CN); Yanliang Sun, Shenzhen (CN)

(21) Appl. No.: 16/345,566

(22) PCT Filed: Oct. 28, 2016
(86) PCT No.: PCT/CN2016/103857

§ 371 Date: Apr. 26, 2019

(51) Int. Cl. H04B 7/06; H04L 5/00; H04B 7/10

(52) U.S. Cl. CPC H04B 7/0626; H04B 7/0617; H04B 7/10; H04L 5/0051

(57) ABSTRACT

The present invention provides an information transmission method, an access network device, and a terminal device. The method includes: sending, by an access network device, a CSI-RS configuration parameter to UE; and receiving, by the access network device after sending a CSI-RS signal at each level to the UE based on a quantity of CSI-RS signals at each level, a beamforming parameter at each level that is reported by the UE for the CSI-RS signal at each level. Therefore, accuracy of a beam direction reported to the access network device is improved.

### TECHNICAL FIELD

The present invention relates to communications technologies, and in particular, to an information transmission method, an access network device, and a terminal device.

### BACKGROUND

In a conventional fourth-generation mobile communications system, to better perform downlink data transmission, channel measurement usually needs to be performed on a downlink. To be specific, a terminal device (User Equipment, UE for short) may perform channel estimation based on a channel state information-reference signal (Channel State Information-Reference Signal, CSI-RS for short) delivered by a base station side, and then perform CSI feedback for the base station side, so that the base station side can perform downlink data transmission based on a CSI-RS sequence number or a beamforming vector that is fed back.

In the prior art, a base station side may send CSI-RSs to a terminal device at two levels, and the UE correspondingly performs CSI feedback at two levels. Specifically, the base station side defines resources required for sending a plurality of CSI-RS signals, and when sending a CSI-RS at a first level, the base station side performs beamforming on each CSI-RS by using a corresponding beamforming factor on a specified resource, and then sends the CSI-RS to the UE, where CSI-RSs obtained after beamforming are corresponding to different beamforming factors. The UE performs channel estimation based on the received CSI-RS signal obtained after the beamforming, to select a CSI-RS sequence number (the CSI-RS sequence number may be corresponding to a beam sequence number) corresponding to a CSI-RS signal with optimal signal quality, and reports the CSI-RS sequence number to the base station side. This is first-level CSI feedback of the UE. The base station side then performs, based on the CSI-RS sequence number reported by the UE, beamforming on a to-be-sent CSI-RS signal at a second level by using a corresponding narrow beam, and delivers the CSI-RS signal to the UE. The UE continues to perform channel estimation based on the CSI-RS signal delivered at the second level, to select a CSI-RS sequence number corresponding to a CSI-RS signal with optimal signal quality, and reports the CSI-RS sequence number to the base station side. This is second-level CSI feedback of the UE. The base station side then may learn of a current beamforming direction based on the CSI-RS sequence number fed back by the UE at the second level, and may further perform downlink data transmission by using a waveform in the direction.

However, in the prior art, the CSI-RS sequence number reported by the UE is inaccurate, in other words, the CSI-RS beamforming direction reported by the UE is inaccurate. Consequently, average frequency efficiency of a cell and frequency efficiency of a cell-edge user are reduced, and unnecessary interference between neighboring cells is caused.

### SUMMARY

Embodiments of the present invention provide an information transmission method, an access network device, and a terminal device, to resolve a prior-art problem that because a CSI-RS sequence number reported by UE is inaccurate, in other words, a CSI-RS beamforming direction reported by the UE is inaccurate, average frequency efficiency of a cell and frequency efficiency of a cell-edge user are reduced and unnecessary interference between neighboring cells is caused because a CSI-RS sequence number reported by UE is inaccurate, in other words, a CSI-RS beamforming direction reported by the UE is inaccurate.

According to a first aspect, an embodiment of the present invention provides an information transmission method, including:

sending, by an access network device, a channel state information-reference signal CSI-RS configuration parameter to a terminal device UE, where the CSI-RS configuration parameter includes a quantity of CSI-RS signals to be sent by the access network device at each level and a sampling rate at each level; and

receiving, by the access network device after sending, based on the quantity of CSI-RS signals at each level, a CSI-RS signal corresponding to each level to the UE, a beamforming parameter at each level that is reported by the UE for the CSI-RS signal at each level, where the beamforming parameter at each level is determined by the UE based on the CSI-RS signal at each level and the sampling rate at each level, a width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

According to the information transmission method provided in the first aspect, the access network device sends, to the UE, the CSI-RS configuration parameter that includes the quantity of CSI-RS signals at each level and the sampling rate at each level, and after sending, based on the quantity of CSI-RS signals at each level, the CSI-RS signal corresponding to each level to the UE, the access network device receives the beamforming parameter at each level that is reported by the UE for the CSI-RS signal at each level. The UE may calculate an accurate beamforming parameter based on the CSI-RS configuration parameter and the CSI-RS signal delivered at each level, the width of the beam represented by the beamforming parameter at each level is less than the width of the beamforming used for delivering the CSI-RS signal at each level, and the width of the beamforming used for delivering the CSI-RS signal at the current level is less than or equal to the width of the beam represented by the beamforming parameter reported at the previous level. Therefore, there may be a plurality of beam width decrease processes in this embodiment of the present invention, so that a width of a beam represented by a beamforming parameter finally reported by the UE to the access network device is far less than a width of a beam reported by UE to an access network device at a second level in the prior art, accuracy of a beam direction is greatly improved, and the beam is more directive. Therefore, when the access network device performs downlink data transmission, interference between neighboring cells can be obviously avoided, and average frequency efficiency of a cell and frequency efficiency of a cell-edge user are greatly improved.

In a possible design, the quantity of CSI-RS signals to be sent at each level includes a quantity of CSI-RS signals that have a same polarization direction in a horizontal direction and a quantity of CSI-RS signals that have a same polarization direction in a vertical direction, and the sampling rate at each level includes a sampling rate in the horizontal direction and a sampling rate in the vertical direction.

In a possible design, the CSI-RS configuration parameter further includes a CSI-RS send window parameter, the CSI-RS send window parameter is used to represent a sending manner of the CSI-RS signal at each level, and the sending manner includes at least one of the following manners: a manner in which the CSI-RS signal at each level is sent by using a time domain window, a manner in which the CSI-RS signal at each level is sent by using a frequency domain window, or a manner in which the CSI-RS signal at each level is sent by using both a time domain window and a frequency domain window

In a possible design, the CSI-RS configuration parameter includes a quantity of CSI-RS signals to be sent by the access network device at a first level, a quantity of CSI-RSs to be sent at a second level, a sampling rate at the first level, and a sampling rate at the second level, and the receiving, by the access network device after sending, based on the quantity of CSI-RS signals at each level, a CSI-RS signal corresponding to each level to the UE, a beamforming parameter at each level that is reported by the UE for the CSI-RS signal at each level specifically includes:

after sending a first CSI-RS signal to the UE based on the quantity of CSI-RS signals to be sent at the first level and a preset first beam group, receiving, by the access network device, a first beamforming parameter reported by the UE based on the quantity of CSI-RS signals to be sent at the first level, the sampling rate at the first level, and the first CSI-RS signal, where a width of a beam represented by the first beamforming parameter is less than a width of a beam in the first beam group, a quantity of beams in the first beam group is equal to a quantity of first CSI-RS signals, and all the first CSI-RS signals have a same beamforming factor;

determining, by the access network device, a second beam group based on the first beamforming parameter, and sending a second CSI-RS signal to the UE based on the quantity of CSI-RS signals to be sent at the second level and the second beam group, where a width of a beam in the second beam group is less than or equal to the width of the beam represented by the first beamforming parameter, a quantity of beams in the second beam group is equal to a quantity of second CSI-RS signals, and all the second CSI-RS signals have a same beamforming factor; and

receiving, by the access network device, a second beamforming parameter reported by the UE based on the quantity of CSI-RS signals to be sent at the second level, the sampling rate at the second level, and the second CSI-RS signal, where a width of beamforming represented by the second beamforming parameter is less than the width of the beam in the second beam group.

In a possible design, the first beamforming parameter includes an identifier of a first main beam in a horizontal antenna direction, an identifier of a second main beam in a vertical antenna direction, an offset relative to the first main beam in the horizontal antenna direction, and an offset relative to the second main beam in the vertical antenna direction; and

the second beamforming parameter includes an identifier of a beam in the horizontal antenna direction, an identifier of a beam in the vertical antenna direction, and a phase difference in two antenna polarization directions.

According to the information transmission method provided in the foregoing possible designs, the access network device sends, to the UE, the CSI-RS configuration parameter that includes the quantity of CSI-RS signals at each level and the sampling rate at each level, and then sends the first CSI-RS signal to the UE based on the quantity of CSI-RS signals to be sent at the first level and the preset first beam group, so that the UE determines the first beamforming parameter based on the quantity of CSI-RS signals to be sent at the first level, the sampling rate at the first level, and the first CSI-RS signal, and reports the first beamforming parameter to the access network device, and the access network device then determines the second beam group based on the first beamforming parameter, and sends the second CSI-RS signal to the UE based on the quantity of CSI-RS signals to be sent at the second level and the second beam group, so that the UE determines the second beamforming parameter based on the quantity of CSI-RS signals to be sent at the second level, the sampling rate at the second level, and the second CSI-RS signal, and reports the second beamforming parameter to the access network device. The UE may calculate the accurate beamforming parameter based on the CSI-RS configuration parameter and the CSI-RS signal delivered at each level, the width of the beam represented by the beamforming parameter at each level is less than the width of the beamforming used for delivering the CSI-RS signal at each level, and the width of the beamforming used for delivering the CSI-RS signal at the current level is less than or equal to the width of the beam represented by the beamforming parameter reported at the previous level. Therefore, there may be a plurality of beam width decrease processes in this embodiment of the present invention, so that the width of the beam represented by the beamforming parameter finally reported by the UE to the access network device is far less than the width of the beam reported by the UE to the access network device at the second level in the prior art, accuracy of the beam direction is greatly improved, and the beam is more directive. Therefore, when the access network device performs downlink data transmission, interference between neighboring cells can be obviously avoided, and average frequency efficiency of a cell and frequency efficiency of a cell-edge user are greatly improved.

In a possible design, the CSI-RS send window parameter includes a first send window parameter and a second send window parameter, and the first send window parameter includes a start sending symbol or subframe of a CSI-RS signal in time domain, a symbol or subframe offset of the CSI-RS signal in time domain, and a total quantity of symbols or subframes occupied by the CSI-RS signal in time domain, and is used to indicate, to the UE, that the access network device sends a CSI-RS signal at the first level by using the time domain window; and

the second send window parameter includes a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and is used to indicate, to the UE, that the access network device sends a CSI-RS signal at the second level by using the frequency domain window.

According to the information transmission method provided in the possible design, the access network device sends the CSI-RS signal at the first level in the time domain window, and sends the CSI-RS signal at the second level in the frequency domain window Therefore, not only coverage performance of the CSI-RS signal at the first level can be enhanced, but also a measurement rate of the CSI-RS signal at the second level can be accelerated, thereby improving channel measurement accuracy, and improving a traffic channel transmission rate.

According to a second aspect, an embodiment of the present invention provides an information transmission method, including:

receiving, by a terminal device UE, a channel state information-reference signal CSI-RS configuration parameter sent by an access network device, where the CSI-RS configuration parameter includes a quantity of CSI-RS signals to be sent by the access network device at each level and a sampling rate at each level; and

reporting, by the UE to the access network device, a beamforming parameter at each level based on a CSI-RS signal at each level and the sampling rate at each level after receiving the CSI-RS signal at each level that is sent by the access network device, where a width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

In a possible design, the quantity of CSI-RS signals to be sent at each level includes a quantity of CSI-RS signals that have a same polarization direction in a horizontal direction and a quantity of CSI-RS signals that have a same polarization direction in a vertical direction, and the sampling rate at each level includes a sampling rate in the horizontal direction and a sampling rate in the vertical direction.

In a possible design, the CSI-RS configuration parameter further includes a CSI-RS send window parameter, the CSI-RS send window parameter is used to represent a sending manner of the CSI-RS signal at each level, and the sending manner includes at least one of the following manners: a manner in which the CSI-RS signal at each level is sent by using a time domain window, a manner in which the CSI-RS signal at each level is sent by using a frequency domain window, or a manner in which the CSI-RS signal at each level is sent by using both a time domain window and a frequency domain window.

In a possible design, the CSI-RS configuration parameter includes a quantity of CSI-RS signals to be sent by the access network device at a first level, a quantity of CSI-RSs to be sent at a second level, a sampling rate at the first level, and a sampling rate at the second level, and the reporting, by the UE to the access network device, a beamforming parameter at each level based on a CSI-RS signal at each level and the sampling rate at each level after receiving the CSI-RS signal at each level that is sent by the access network device specifically includes:

after receiving a first CSI-RS signal sent by the access network device based on the quantity of CSI-RS signals to be sent at the first level and a first beam group, determining, by the UE, a first beamforming parameter based on the quantity of CSI-RS signals to be sent at the first level, the sampling rate at the first level, and the first CSI-RS signal, and reporting the first beamforming parameter to the access network device, where a width of a beam represented by the first beamforming parameter is less than a width of a beam in the first beam group, a quantity of beams in the first beam group is equal to a quantity of first CSI-RS signals, and all the first CSI-RS signals have a same beamforming factor; and

after receiving a second CSI-RS signal sent by the access network device based on the quantity of CSI-RS signals to be sent at the second level and a second beam group, determining, by the UE, a second beamforming parameter based on the quantity of CSI-RS signals to be sent at the second level, the sampling rate at the second level, and the second CSI-RS signal, and reporting the second beamforming parameter to the access network device, where the second beam group is determined by the access network device based on the first beamforming parameter, a width of a beam in the second beam group is less than or equal to the width of the beam represented by the first beamforming parameter, a quantity of beams in the second beam group is equal to a quantity of second CSI-RS signals, all the second CSI-RS signals have a same beamforming factor, and a width of beamforming represented by the second beamforming parameter is less than the width of the beam in the second beam group.

In a possible design, the first beamforming parameter includes an identifier of a first main beam in a horizontal antenna direction, an identifier of a second main beam in a vertical antenna direction, an offset relative to the first main beam in the horizontal antenna direction, and an offset relative to the second main beam in the vertical antenna direction; and

the second beamforming parameter includes an identifier of a beam in the horizontal antenna direction, an identifier of a beam in the vertical antenna direction, and a phase difference in two antenna polarization directions.

In a possible design, the CSI-RS send window parameter includes a first send window parameter and a second send window parameter, and the first send window parameter includes a start sending symbol or subframe of a CSI-RS signal in time domain, a symbol or subframe offset of the CSI-RS signal in time domain, and a total quantity of symbols or subframes occupied by the CSI-RS signal in time domain, and is used to indicate, to the UE, that the access network device sends a CSI-RS signal at the first level by using the time domain window; and

the second send window parameter includes a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and is used to indicate, to the UE, that the access network device sends a CSI-RS signal at the second level by using the frequency domain window.

For beneficial effects of the information transmission method provided in the second aspect and the possible designs of the second aspect, refer to the beneficial effects brought by the first aspect and the possible designs of the first aspect. Details are not described herein.

According to a third aspect, an embodiment of the present invention provides an access network device, including:

a sending module, configured to send a channel state information-reference signal CSI-RS configuration parameter to a terminal device UE, where the CSI-RS configuration parameter includes a quantity of CSI-RS signals to be sent by the access network device at each level and a sampling rate at each level; and

a receiving module, configured to: after the sending module sends, based on the quantity of CSI-RS signals at each level, a CSI-RS signal corresponding to each level to the UE, receive a beamforming parameter at each level that is reported by the UE for the CSI-RS signal at each level, where the beamforming parameter at each level is determined by the UE based on the CSI-RS signal at each level and the sampling rate at each level, a width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

In a possible design, the quantity of CSI-RS signals to be sent at each level includes a quantity of CSI-RS signals that have a same polarization direction in a horizontal direction and a quantity of CSI-RS signals that have a same polarization direction in a vertical direction, and the sampling rate at each level includes a sampling rate in the horizontal direction and a sampling rate in the vertical direction.

In a possible design, the CSI-RS configuration parameter further includes a CSI-RS send window parameter, the CSI-RS send window parameter is used to represent a sending manner of the CSI-RS signal at each level, and the sending manner includes at least one of the following manners: a manner in which the CSI-RS signal at each level is sent by using a time domain window, a manner in which the CSI-RS signal at each level is sent by using a frequency domain window, or a manner in which the CSI-RS signal at each level is sent by using both a time domain window and a frequency domain window.

In a possible design, the CSI-RS configuration parameter includes a quantity of CSI-RS signals to be sent by the access network device at a first level, a quantity of CSI-RSs to be sent at a second level, a sampling rate at the first level, and a sampling rate at the second level, and the receiving module specifically includes:

a first receiving unit, configured to: after the sending module sends a first CSI-RS signal to the UE based on the quantity of CSI-RS signals to be sent at the first level and a preset first beam group, receive a first beamforming parameter reported by the UE based on the quantity of CSI-RS signals to be sent at the first level, the sampling rate at the first level, and the first CSI-RS signal, where a width of a beam represented by the first beamforming parameter is less than a width of a beam in the first beam group, a quantity of beams in the first beam group is equal to a quantity of first CSI-RS signals, and all the first CSI-RS signals have a same beamforming factor;

a determining unit, configured to determine a second beam group based on the first beamforming parameter, where

the sending module is further configured to send a second CSI-RS signal to the UE based on the quantity of CSI-RS signals to be sent at the second level and the second beam group, where a width of a beam in the second beam group is less than or equal to the width of the beam represented by the first beamforming parameter, a quantity of beams in the second beam group is equal to a quantity of second CSI-RS signals, and all the second CSI-RS signals have a same beamforming factor; and

a second receiving unit, configured to receive a second beamforming parameter reported by the UE based on the quantity of CSI-RS signals to be sent at the second level, the sampling rate at the second level, and the second CSI-RS signal, where a width of beamforming represented by the second beamforming parameter is less than the width of the beam in the second beam group.

in a possible design, the first beamforming parameter includes an identifier of a first main beam in a horizontal antenna direction, an identifier of a second main beam in a vertical antenna direction, an offset relative to the first main beam in the horizontal antenna direction, and an offset relative to the second main beam in the vertical antenna direction; and

the second beamforming parameter includes an identifier of a beam in the horizontal antenna direction, an identifier of a beam in the vertical antenna direction, and a phase difference in two antenna polarization directions.

In a possible design, the CSI-RS send window parameter includes a first send window parameter and a second send window parameter, and the first send window parameter includes a start sending symbol or subframe of a CSI-RS signal in time domain, a symbol or subframe offset of the CSI-RS signal in time domain, and a total quantity of symbols or subframes occupied by the CSI-RS signal in time domain, and is used to indicate, to the UE, that the access network device sends a CSI-RS signal at the first level by using the time domain window; and

the second send window parameter includes a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and is used to indicate, to the UE, that the access network device sends a CSI-RS signal at the second level by using the frequency domain window.

For beneficial effects of the access network device provided in the third aspect and the possible designs of the third aspect, refer to the beneficial effects brought by the first aspect and the possible designs of the first aspect. Details are not described herein.

According to a fourth aspect, an embodiment of the present invention provides a terminal device, including a receiving module, a processing module, and a sending module, where

the receiving module is configured to receive a channel state information-reference signal CSI-RS configuration parameter sent by an access network device, where the CSI-RS configuration parameter includes a quantity of CSI-RS signals to be sent by the access network device at each level and a sampling rate at each level; and

the processing module is configured to: after the receiving module receives a CSI-RS signal at each level that is sent by the access network device, determine a beamforming parameter at each level based on the CSI-RS signal at each level and the sampling rate at each level, and report the beamforming parameter at each level to the access network device by using the sending module, where a width of a beam represented by the beamforming parameter at each level is less than a width of beamforming used for delivering the CSI-RS signal at each level, and a width of beamforming used for delivering a CM-RS signal at a current level is less than or equal to a width of a beam represented by a beamforming parameter reported at a previous level.

In a possible design, the quantity of CSI-RS signals to be sent at each level includes a quantity of CSI-RS signals that have a same polarization direction in a horizontal direction and a quantity of CSI-RS signals that have a same polarization direction in a vertical direction, and the sampling rate at each level includes a sampling rate in the horizontal direction and a sampling rate in the vertical direction.

In a possible design, the CSI-RS configuration parameter further includes a CSI-RS send window parameter, the CSI-RS send window parameter is used to represent a sending manner of the CSI-RS signal at each level, and the sending manner includes at least one of the following manners: a manner in which the CSI-RS signal at each level is sent by using a rime domain window, a manner in which the CSI-RS signal at each level is sent by using a frequency domain window, or a manner in which the CSI-RS signal at each level is sent by using both a time domain window and a frequency domain window

In a possible design, the CSI-RS configuration parameter includes a quantity of CSI-RS signals to be sent by the access network device at a first level, a quantity of CSI-RSs to be sent at a second level, a sampling rate at the first level, and a sampling rate at the second level, and the processing module specifically includes:

a first processing unit, configured to: after the receiving module receives a first CSI-RS signal sent by the access network device based on the quantity of CSI-RS signals to be sent at the first level and a first beam group, determine a first beamforming parameter based on the quantity of CSI-RS signals to be sent at the first level, the sampling rate at the first level, and the first CSI-RS signal, and report the first beamforming parameter to the access network device by using the sending module, where a width of a beam represented by the first beamforming parameter is less than a width of a beam in the first beam group, a quantity of beams in the first beam group is equal to a quantity of first CSI-RS signals, and all the first CSI-RS signals have a same beamforming factor; and

a second processing unit, configured to: after the receiving module receives a second CSI-RS signal sent by the access network device based on the quantity of CSI-RS signals to be sent at the second level and a second beam group, determine a second beamforming parameter based on the quantity of CSI-RS signals to be sent at the second level, the sampling rate at the second level, and the second CSI-RS signal, and report the second beamforming parameter to the access network device by using the sending module, where the second beam group is determined by the access network device based on the first beamforming parameter, a width of a beam in the second beam group is less than or equal to the width of the beam represented by the first beamforming parameter, a quantity of beams in the second beam group is equal to a quantity of second CSI-RS signals, all the second CSI-RS signals have a same beamforming factor, and a width of beamforming represented by the second beamforming parameter is less than the width of the beam in the second beam group.

In a possible design, the first beamforming parameter includes an identifier of a first main beam in a horizontal antenna direction, an identifier of a second main beam in a vertical antenna direction, an offset relative to the first main beam in the horizontal antenna direction, and an offset relative to the second main beam in the vertical antenna direction; and

the second beamforming parameter includes an identifier of a beam in the horizontal antenna direction, an identifier of a beam in the vertical antenna direction, and a phase difference in two antenna polarization directions.

In a possible design, the CSI-RS send window parameter includes a first send window parameter and a second send window parameter, and the first send window parameter includes a start sending symbol or subframe of a CSI-RS signal in time domain, a symbol or subframe offset of the CSI-RS signal in time domain, and a total quantity of symbols or subframes occupied by the CSI-RS signal in time domain, and is used to indicate, to the UE, that the access network device sends a CSI-RS signal at the first level by using the time domain window; and

the second send window parameter includes a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and is used to indicate, to the UE, that the access network device sends a CSI-RS signal at the second level by using the frequency domain window

For beneficial effects of the terminal device provided in the fourth aspect and the possible designs of the fourth aspect, refer to the beneficial effects brought by the first aspect and the possible designs of the first aspect. Details are not described herein.

According to a fifth aspect, an embodiment of the present invention provides an access network device, including:

a transmitter, configured to send a channel state information-reference signal CSI-RS configuration parameter to a terminal device UE, where the CSI-RS configuration parameter includes a quantity of CSI-RS signals to be sent by the access network device at each level and a sampling rate at each level; and

a receiver, configured to: after the transmitter sends, based on the quantity of CSI-RS signals at each level, a CSI-RS signal corresponding to each level to the UE, receive a beamforming parameter at each level that is reported by the UE for the CSI-RS signal at each level, where the beamforming parameter at each level is determined by the UE based on the CSI-RS signal at each level and the sampling rate at each level, a width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

In a possible design, the quantity of CSI-RS signals to be sent at each level includes a quantity of CSI-RS signals that have a same polarization direction in a horizontal direction and a quantity of CSI-RS signals that have a same polarization direction in a vertical direction, and the sampling rate at each level includes a sampling rate in the horizontal direction and a sampling rate in the vertical direction.

In a possible design, the CSI-RS configuration parameter further includes a CSI-RS send window parameter, the CSI-RS send window parameter is used to represent a sending manner of the CSI-RS signal at each level, and the sending manner includes at least one of the following manners: a manner in which the CSI-RS signal at each level is sent by using a time domain window, a manner in which the CSI-RS signal at each level is sent by using a frequency domain window, or a manner in which the CSI-RS signal at each level is sent by using both a time domain window and a frequency domain window.

In a possible design, the CSI-RS configuration parameter includes a quantity of CSI-RS signals to be sent by the access network device at a first level, a quantity of CSI-RSs to be sent at a second level, a sampling rate at the first level, and a sampling rate at the second level;

the receiver is specifically configured to: after the transmitter sends a first CSI-RS signal to the UE based on the quantity of CSI-RS signals to be sent at the first level and a preset first beam group, receive a first beamforming parameter reported by the UE based on the quantity of CSI-RS signals to be sent at the first level, the sampling rate at the first level, and the first CSI-RS signal, where a width of a beam represented by the first beamforming parameter is less than a width of a beam in the first beam group, a quantity of beams in the first beam group is equal to a quantity of first CSI-RS signals, and all the first CSI-RS signals have a same beamforming factor;

the transmitter is configured to send a second CSI-RS signal to the UE based on the quantity of CSI-RS signals to be sent at the second level and a second beam group determined by the processor with reference to the first beamforming parameter, where a width of a beam in the second beam group is less than or equal to the width of the beam represented by the first beamforming parameter, a quantity of beams in the second beam group is equal to a quantity of second CSI-RS signals, and all the second CSI-RS signals have a same beamforming factor; and

the receiver is further configured to receive a second beamforming parameter reported by the UE based on the quantity of CSI-RS signals to be sent at the second level, the sampling rate at the second level, and the second CSI-RS signal, where a width of beamforming represented by the second beamforming parameter is less than the width of the beam in the second beam group.

In a possible design, the first beamforming parameter includes an identifier of a first main beam in a horizontal antenna direction, an identifier of a second main beam in a vertical antenna direction, an offset relative to the first main beam in the horizontal antenna direction, and an offset relative to the second main beam in the vertical antenna direction; and

the second beamforming parameter includes an identifier of a beam in the horizontal antenna direction, an identifier of a beam in the vertical antenna direction, and a phase difference in two antenna polarization directions.

In a possible design, the CSI-RS send window parameter includes a first send window parameter and a second send window parameter, and the first send window parameter includes a start sending symbol or subframe of a CSI-RS signal in time domain, a symbol or subframe offset of the CSI-RS signal in time domain, and a total quantity of symbols or subframes occupied by the CSI-RS signal in time domain, and is used to indicate, to the UE, that the access network device sends a CSI-RS signal at the first level by using the time domain window; and

the second send window parameter includes a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and is used to indicate, to the UE, that the access network device sends a CSI-RS signal at the second level by using the frequency domain window.

For beneficial effects of the access network device provided in the fifth aspect and the possible designs of the fifth aspect, refer to the beneficial effects brought by the first aspect and the possible designs of the first aspect. Details are not described herein.

According to a sixth aspect, an embodiment of the present invention provides a terminal device, including: a receiver, a processor, and a transmitter, where

the receiver is configured to receive a channel state information-reference signal CSI-RS configuration parameter sent by an access network device, where the CSI-RS configuration parameter includes a quantity of CSI-RS signals to be sent by the access network device at each level and a sampling rate at each level; and

the processor is configured to: after the receiver receives a CSI-RS signal at each level that is sent by the access network device, determine a beamforming parameter at each level based on the CSI-RS signal at each level and the sampling rate at each level, and report the beamforming parameter at each level to the access network device by using the transmitter, where a width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

In a possible design, the quantity of CSI-RS signals to be sent at each level includes a quantity of CSI-RS signals that have a same polarization direction in a horizontal direction and a quantity of CSI-RS signals that have a same polarization direction in a vertical direction, and the sampling rate at each level includes a sampling rate in the horizontal direction and a sampling rate in the vertical direction.

In a possible design, the CSI-RS configuration parameter further includes a CSI-RS send window parameter, the CSI-RS send window parameter is used to represent a sending manner of the CSI-RS signal at each level, and the sending manner includes at least one of the following manners: a manner in which the CSI-RS signal at each level is sent by using a time domain window, a manner in which the CSI-RS signal at each level is sent by using a frequency domain window, or a manner in which the CSI-RS signal at each level is sent by using both a time domain window and a frequency domain window

In a possible design, the CSI-RS configuration parameter includes a quantity of CSI-RS signals to be sent by the access network device at a first level, a quantity of CSI-RSs to be sent at a second level, a sampling rate at the first level, and a sampling rate at the second level;

the processor is specifically configured to: after the receiver receives a first CSI-RS signal sent by the access network device based on the quantity of CSI-RS signals to be sent at the first level and a first beam group, determine a first beamforming parameter based on the quantity of CSI-RS signals to be sent at the first level, the sampling rate at the first level, and the first CSI-RS signal, and report the first beamforming parameter to the access network device by using the transmitter, where a width of a beam represented by the first beamforming parameter is less than a width of a beam in the first beam group, a quantity of beams in the first beam group is equal to a quantity of first CSI-RS signals, and all the first CSI-RS signals have a same beamforming factor; and

the processor is further configured to: after the receiver receives a second CSI-RS signal sent by the access network device based on the quantity of CSI-RS signals to be sent at the second level and a second beam group, determine a second beamforming parameter based on the quantity of CSI-RS signals to be sent at the second level, the sampling rate at the second level, and the second CSI-RS signal, and report the second beamforming parameter to the access network device by using the transmitter, where the second beam group is determined by the access network device based on the first beamforming parameter, a width of a beam in the second beam group is less than or equal to the width of the beam represented by the first beamforming parameter, a quantity of beams in the second beam group is equal to a quantity of second CSI-RS signals, all the second CSI-RS signals have a same beamforming factor, and a width of beamforming represented by the second beamforming parameter is less than the width of the beam in the second beam group.

In a possible design, the first beamforming parameter includes an identifier of a first main beam in a horizontal antenna direction, an identifier of a second main beam in a vertical antenna direction, an offset relative to the first main beam in the horizontal antenna direction, and an offset relative to the second main beam in the vertical antenna direction; and

the second beamforming parameter includes an identifier of a beam in the horizontal antenna direction, an identifier of a beam in the vertical antenna direction, and a phase difference in two antenna polarization directions.

In a possible design, the CSI-RS send window parameter includes a first send window parameter and a second send window parameter, and the first send window parameter includes a start sending symbol or subframe of a CSI-RS signal in time domain, a symbol or subframe offset of the CSI-RS signal in time domain, and a total quantity of symbols or subframes occupied by the CSI-RS signal in time domain, and is used to indicate, to the UE, that the access network device sends a CSI-RS signal at the first level by using the time domain window; and

the second send window parameter includes a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and is used to indicate, to the UE, that the access network device sends a CSI-RS signal at the second level by using the frequency domain window.

For beneficial effects of the terminal device provided in the sixth aspect and the possible designs of the sixth aspect, refer to the beneficial effects brought by the first aspect and the possible designs of the first aspect. Details are not described herein.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and persons of ordinary skill in the art may derive other drawings from these accompanying drawings without creative efforts.

FIG. 1 is a schematic diagram of a scenario of a mobile communications system according to an embodiment of the present invention;

FIG. 2 is a signaling flowchart of Embodiment 1 of an information transmission method according to an embodiment of the present invention;

FIG. 3 is a signaling flowchart of Embodiment 2 of an information transmission method according to an embodiment of the present invention;

FIG. 4 is a schematic diagram of feeding back a beamforming parameter according to an embodiment of the present invention;

FIG. 5 is a schematic diagram of an antenna model in a 5G mobile communications system according to an embodiment of the present invention;

FIG. 6 is a schematic diagram of sending a CSI-RS according to an embodiment of the present invention;

FIG. 7 is a schematic structural diagram of Embodiment 1 of an access network device according to an embodiment of the present invention;

FIG. 8 is a schematic structural diagram of Embodiment 2 of an access network device according to an embodiment of the present invention;

FIG. 9 is a schematic structural diagram of Embodiment 1 of a terminal device according to an embodiment of the present invention;

FIG. 10 is a schematic structural diagram of Embodiment 2 of a terminal device according to an embodiment of the present invention;

FIG. 11 is a schematic structural diagram of Embodiment 3 of an access network device according to an embodiment of the present invention; and

FIG. 12 is a schematic structural diagram of Embodiment 3 of a terminal device according to an embodiment of the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

An information transmission method in the embodiments of the present invention is applicable to a downlink in any mobile communications system in which a plurality of antennas are used, for example, a 5G communications system in which a plurality of antennas are used, or a Long Term Evolution (Long Term Evolution, LTE for short) system in which a multiple-antenna system is used or an evolved version thereof; and is also applicable to sending of an uplink sounding reference signal. For example, as shown in FIG. 1, the communications system in which a plurality of antennas are used may include an access network device and at least one terminal device. The access network device delivers a CSI-RS signal to the terminal device, so that the UE performs CSI feedback for the access network device based on the CSI-RS signal. In the embodiments of the present invention, when the UE performs CSI feedback for the access network device, information that is actually fed back is a beam forming parameter, and the access network device can perform downlink data transmission based on the beamforming parameter.

Optionally, the access network device may be a base station, or may be another communications device that can communicate with the UE and that can perform downlink scheduling. Optionally, the base station in this application may be a device that communicates with a wireless terminal by using one or more sectors on an air interface in an access network. The base station may be configured to mutually convert a received over-the-air frame and an IP packet and serve as a router between the wireless terminal and a remaining part of the access network. The remaining part of the access network may include an Internet protocol (IP) network. The base station may further coordinate attribute management of the air interface. For example, the base station may be an evolved NodeB (NodeB, eNB, or e-NodeB, evolved NodeB) in LTE.

The terminal device in this application may be a wireless terminal device or a wired terminal device. The wireless terminal may be a handheld device with a wireless connection function, another processing device connected to a wireless modem, or a mobile terminal that communicates with one or more core networks by using a radio access network. For example, the wireless terminal may be a mobile phone (or referred to as a “cellular” phone) or a computer with a mobile terminal. For another example, the wireless terminal may alternatively be a portable, pocket-sized, handheld, computer built-in, or in-vehicle mobile apparatus. For still another example, the wireless terminal may be user equipment (English: user equipment, UE for short).

In the prior art, an access network device delivers CSI-RS signals to UE at two levels, and the UE performs CSI feedback for the access network device based on a CSI-RS signal delivered at each level. A basic principle of the CSI feedback is as follows: The UE performs channel estimation based on the CSI-RS signal delivered at each level, to select a CSI-RS sequence number corresponding to a CSI-RS signal with optimal signal quality, and reports the CSI-RS sequence number to a base station side. After receiving the CSI-RS signal, the UE merely performs simple beam selection. Therefore, in the prior art, the CSI-RS sequence number reported by the UE is inaccurate, in other words, a CSI-RS beamforming direction reported by the UE is inaccurate. Consequently, average frequency efficiency of a cell and frequency efficiency of a cell-edge user are reduced, and unnecessary interference between neighboring cells is caused. The method in the embodiments of the present invention is intended to resolve the foregoing problem in the prior art.

Specific embodiments are used below to describe in detail the technical solutions of the present invention. The following several specific embodiments may be combined with each other, and a same or similar concept or process may not be described repeatedly in some embodiments.

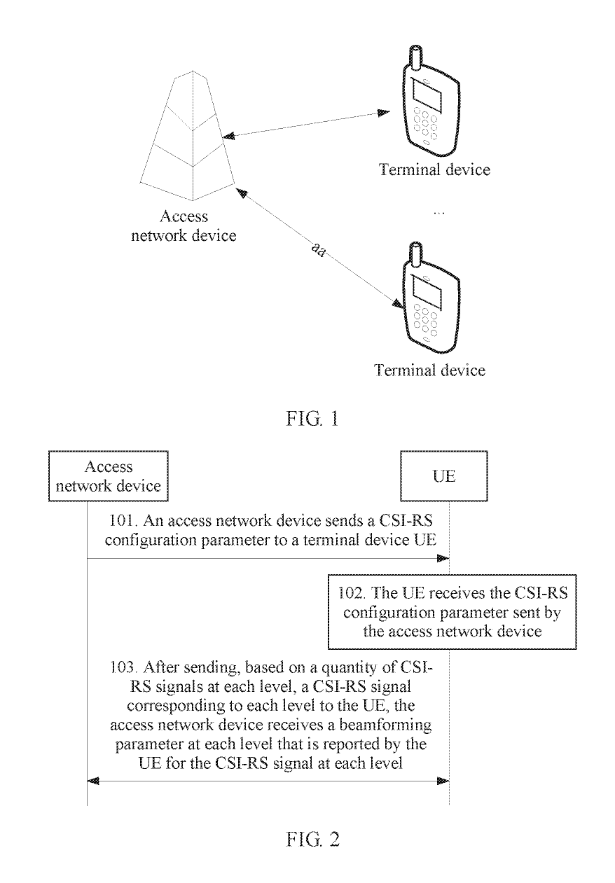

FIG. 2 is a signaling flowchart of Embodiment 1 of an information transmission method according to an embodiment of the present invention. This embodiment relates to a specific process in which an access network device delivers a CSI-RS configuration parameter and a CSI-RS signal to UE so that the UE can obtain, through calculation based on the CSI-RS parameter and a CSI-RS signal delivered at each level, a beamforming parameter corresponding to each level and report the beamforming parameter to the access network device. In this embodiment, a width of a beam represented by the beamforming parameter reported by the UE at each level is less than a width of beamforming used by the UE to deliver the CSI-RS signal at the level, to be specific, the beam represented by the beamforming parameter reported by the UE to the access network device has a more accurate direction and is more directive. Therefore, the access network device performs more accurate downlink data transmission, thereby avoiding interference between neighboring cells.

As shown in FIG. 2, the method includes the following steps.

S101. The access network device sends a CSI-RS configuration parameter to the terminal device UE.

The CSI-RS configuration parameter includes a quantity of CSI-RS signals to be sent by the access network device at each level and a sampling rate at each level.

S102. The UE receives the CSI-RS configuration parameter sent by the access network device.

Specifically, before sending a CSI-RS signal to the UE, the access network device sends the CSI-RS configuration parameter to the UE. The CSI-RS configuration parameter includes the quantity of CSI-RS signals to be sent by the access network device at each level and the sampling rate at each level. The UE may learn of, based on the CSI-RS parameter, a quantity of levels that need to be used by the access network device to deliver CSI-RS signals and the quantity of CSI-RS signals delivered at each level, so that the UE can accurately receive all the CSI-RS signals at each level.

S103. After sending, based on a quantity of CSI-RS signals at each level, a CSI-RS signal corresponding to each level to the UE, the access network device receives a beamforming parameter at each level that is reported by the UE for the CSI-RS signal at each level,

The beamforming parameter at each level is determined by the LIE based on the CSI-RS signal at each level and the sampling rate at each level. A width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

Specifically, after the access network device sends the CSI-RS configuration parameter to the UE, the access network device may send, based on the quantity of the CSI-RS signals at each level that is in the CSI-RI configuration parameter, the CSI-RS signal corresponding to each level to the UE. To be specific, the access network device sends the CSI-RS signals to the UE at levels, and for the CSI-RS signal delivered at each level, the UE reports the beamforming parameter for the CSI-RS signal at the level. The beamforming parameter is determined by the UE based on the CSI-RS signal at the level and the sampling rate at the level. For example, the UE may determine a precoding codebook based on the quantity of CSI-RS signals at the level and the sampling rate at the level, select a beamforming vector (the beamforming vector may be one type of the beamforming parameter) with a maximum downlink transmission rate from the precoding codebook, and feed back a beam vector sequence number to the access network device. For a specific process of determining, by the UE, the beamforming parameter at the level based on the CSI-RS signal at the level and the sampling rate at the level, refer to descriptions in the prior art. This is not limited in this embodiment of the present invention.

The access network device delivers the CSI-RS signals at levels, and therefore the UE reports beamforming parameters to the access network device at levels for the CSI-RS signals delivered at levels. A simple example may be used herein. For example, when the CSI-RS configuration parameter includes a quantity of CSI-RS signals to be sent by the access network device at a first level, a quantity of CSI-RS signals to be sent at a second level, a quantity of CSI-RS signals to be sent at a third level, a sampling rate at the first level, a sampling rate at the second level, and a sampling rate at the third level, when delivering corresponding CSI-RS signals to the UE, the access network device first delivers a CSI-RS signal at the first level to the UE based on the quantity of CSI-RS signals at the first level, then delivers a CSI-RS signal at the second level to the UE after receiving a beamforming parameter at the first level that is reported by the UE based on the quantity of CSI-RS signals at the first level and the sampling rate at the first level, and then delivers a CSI-RS signal at the third level to the UE after receiving a beamforming parameter at the second level that is reported by the UE based on the quantity of CSI-RS signals at the second level and the sampling rate at the second level, to obtain a beamforming parameter at the third level that is reported by the UE based on the quantity of CSI-RS signals at the third level and the sampling rate at the third level. In other words, in this embodiment of the present invention, delivery of the CSI-RS signal at each level is corresponding to reporting of the beamforming parameter at the level.

It should be noted that in this embodiment of the present invention, the CSI-RS signal at each level that is delivered by the access network device to the UE is a signal obtained after beamforming. Optionally, all CSI-RS signals delivered at each level have a same beamforming factor. Optionally, when delivering the CSI-RS signal at each level, the access network device may further perform a sweeping operation on the CSI-RS signal, to obtain a plurality of groups of CSI-RS signals. All CSI-RS signals in each group have a same beamforming factor, but CSI-RS signals in adjacent groups may have different beamforming factors.

In addition, it should be noted that the width of the beam represented by the beamforming parameter at each level is less than the width of the beamforming used for delivering the CSI-RS signal at the level, and the width of the beamforming used for delivering the CSI-RS signal at the current level is less than or equal to the width of the beam represented by the beamforming parameter reported at the previous level. The foregoing example continues to be used herein for description. To be specific, a width of a beam (which is set to a beam a) represented by the beamforming parameter at the first level that is reported by the UE is less than a width of beamforming (which is set to a beam A) used by the access network device to deliver the CSI-RS signal at the first level, a width of a beam (which is set to a beam b) represented by the beamforming parameter at the second level that is reported by the UE is less than a width of beamforming (which is set to a beam B) used by the access network device to deliver the CSI-RS signal at the second level, and a width of a beam (which is set to a beam c) represented by the beamforming parameter at the third level that is reported by the UE is less than a width of beamforming (which is set to a beam group C) used by the access network device to deliver the CSI-RS signal at the third level. In addition, the width of the beamforming (namely, the beam B) used by the access network device to deliver the CSI-RS signal at the second level is less than or equal to the width of the beam (namely, the beam a) represented by the beamforming parameter reported by the UE at the first level, and the width of the beamforming (namely, the beam C) used by the access network device to deliver the CSI-RS signal at the third level is less than or equal to the width of the beam (namely, the beam b) represented by the beamforming parameter reported by the UE at the second level. A specific relationship is “the width of the beam A”>“the width of the beam a”≥“the width of the beam B”>“the width of the beam b”≥“the width of the beam C”>“the width of the beam c”. It may be learned that in the entire process in which delivery and reporting are performed at levels, widths of used beams gradually decrease, the beam (namely, the beam c) represented by the beamforming parameter finally reported to the access network device has a minimum width, and the beam has an accurate beam direction, and is directive. Therefore, when the access network device performs downlink data transmission, interference between neighboring cells can be obviously avoided, and average frequency efficiency of a cell and frequency efficiency of a cell-edge user are greatly improved.

However, in the prior art, UE merely performs simple beam selection based on CSI-RS signals delivered by an access network device at levels. To be specific, the UE selects, from beams used to deliver the CSI-RS signals, a beam corresponding to a CSI-RS signal with high signal quality, and reports a sequence number of the beam to the access network device, in other words, a width of a beam used to deliver a CSI-RS signal at a level is the same as a width of a beam reported to the access network device at the same level. Consequently, a beam finally reported to the access network device still has a relatively large width, and is not directive. For example, in the prior art, CSI-RS signals are delivered at two levels, and CSI-RS sequence numbers are reported at two levels. It is assumed that the access network device performs beamforming on CSI-RS signals at a first level by using a first beam group (the first beam group includes different beams), and then delivers the CSI-RS signals, where all the CSI-RS signals delivered at the first level have different beamforming factors. The UE then selects, based on the CSI-RS signals at the first level, a beam (it is assumed that the beam is a beam D in the first beam group) corresponding to a CSI-RS signal with optimal signal quality, and reports the beam to the access network device. The access network device then determines a relatively narrow second beam group based on the beam D to continue to deliver a CSI-RS signal at a second level. The UE selects a beam E from the second beam group based on a same process. A width of the beam E is less than a width of the beam D. The beam D reported at the first level and the beam D used to deliver a CSI-RS signal at the first level have a same width, and the beam E reported at the second level and the beam E used to deliver a CSI-RS signal at the second level have a same width. Therefore, there is only one beam width decrease process (to be specific, the width of the beam E is less than the width of the beam D) in the prior art. However, in this embodiment of the present invention, the foregoing example is used. There is one beam width decrease process (to be specific, “the width of the beam A”>“the width of the beam a”) in a process from delivery at the first level to reporting at the first level, there may be one beam width decrease process (“the width of the beam a”≥“the width of the beam B”) in a process from reporting at the first level to delivery at the second level, and there is also one beam width decrease process (“the width of the beam B”>“the width of the beam b”) in a process from delivery at the second level to reporting at the second level. Therefore, there are a plurality of beam width decrease processes in this embodiment of the present invention. Therefore, the width of the beam finally reported to the access network device in this embodiment of the present invention is far less than the width of the beam finally reported by the UE to the access network device in the prior art, and the beam has a more accurate beam direction. Therefore, when the access network device performs downlink data transmission, interference between neighboring cells can be obviously avoided, and average frequency efficiency of a cell and frequency efficiency of a cell-edge user are greatly improved.

According to the information transmission method provided in this embodiment of the present invention, the access network device sends, to the UE, the CSI-RS configuration parameter that includes the quantity of CSI-RS signals at each level and the sampling rate at each level, and after sending, based on the quantity of CSI-RS signals at each level, the CSI-RS signal corresponding to each level to the UE, the access network device receives the beamforming parameter at each level that is reported by the UE for the CSI-RS signal at each level. The UE may calculate an accurate beamforming parameter based on the CSI-RS configuration parameter and the CSI-RS signal delivered at each level, the width of the beam represented by the beamforming parameter at each level is less than the width of the beamforming used for delivering the CSI-RS signal at each level, and the width of the beamforming used for delivering the CSI-RS signal at the current level is less than or equal to the width of the beam represented by the beamforming parameter reported at the previous level. Therefore, there may be a plurality of beam width decrease processes in this embodiment of the present invention, so that the width of the beam represented by the beamforming parameter finally reported by the UE to the access network device is far less than the width of the beam reported by the UE to the access network device at the second level in the prior art, accuracy of the beam direction is greatly improved, and the beam is more directive. Therefore, when the access network device performs downlink data transmission, interference between neighboring cells can be obviously avoided, and average frequency efficiency of a cell and frequency efficiency of a cell-edge user are greatly improved.

Optionally, the quantity of the CSI-RS signals to be sent at each level that is in the CSI-RS configuration parameter may include a quantity of CSI-RS signals that have a same polarization direction in a horizontal direction and a quantity of CSI-RS signals that have a same polarization direction in a vertical direction, and the sampling rate at each level may include a sampling rate in the horizontal direction and a sampling rate in the vertical direction.

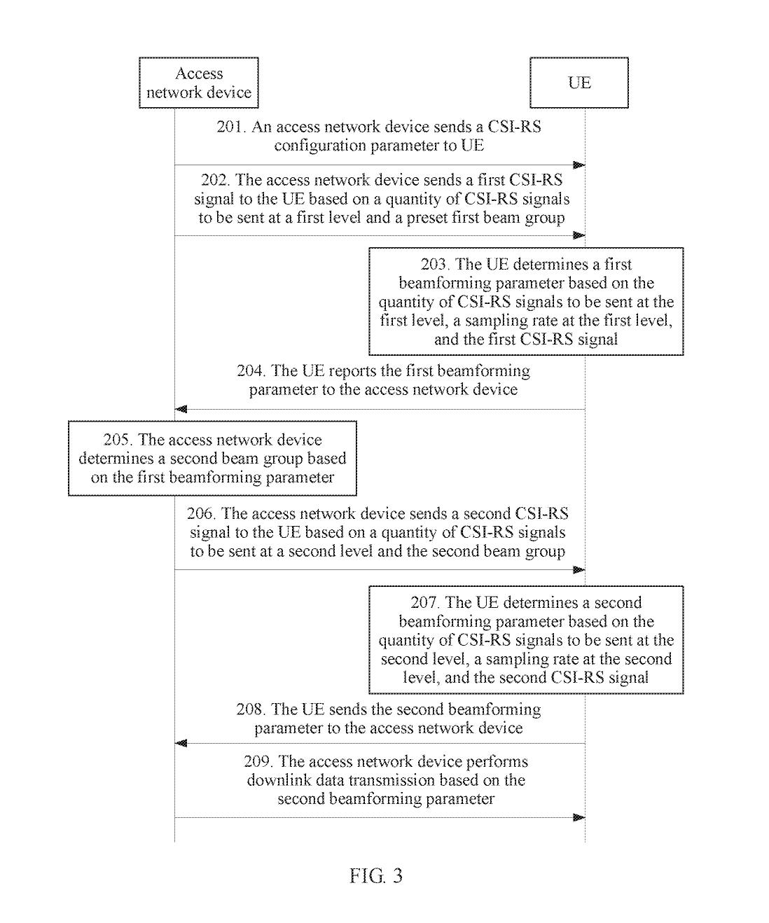

FIG. 3 is a signaling flowchart of Embodiment 2 of an information transmission method according to an embodiment of the present invention. In this embodiment, a CSI-RS configuration parameter includes a quantity of CSI-RS signals to be sent by the access network device at a first level, a quantity of CSI-RSs to be sent at a second level, a sampling rate at the first level, and a sampling rate at the second level. This embodiment relates to a specific process in which the access network device delivers CSI-RS signals at two levels and UE reports beamforming parameters at two levels to improve accuracy of a beam direction reported to a base station. Based on the foregoing embodiment, as shown in FIG. 3, the method includes the following steps.

S201. The access network device sends a CSI-RS configuration parameter to the UE.

The CSI-RS configuration parameter includes a quantity of CSI-RS signals to be sent by the access network device at a first level, a quantity of CSI-RSs to be sent at a second level, a sampling rate at the first level, and a sampling rate at the second level.

Specifically, in the CSI-RS configuration parameter, the quantity of CSI-RS signals to be sent at the first level includes a quantity of CSI-RS signals that are to be sent at the first level and that have a same polarization direction in a horizontal direction and a quantity of CSI-RS signals that are to be sent at the first level and that have a same polarization direction in a vertical direction, the sampling rate at the first level includes a sampling rate of a CSI-RS signal at the first level in the horizontal direction and a sampling rate of a CSI-RS signal at the first level in the vertical direction, the quantity of CSI-RS signals to be sent at the second level includes a quantity of CSI-RS signals that are to be sent at the second level and that have a same polarization direction in a horizontal direction and a quantity of CSI-RS signals that are to be sent at the second level and that have a same polarization direction in a vertical direction, and the sampling rate at the second level includes a sampling rate of a CSI-RS signal at the second level in the horizontal direction and a sampling rate of a CSI-RS signal at the second level in the vertical direction.

S202. The access network device sends a first CSI-RS signal to the UE based on a quantity of CSI-RS signals to be sent at a first level and a preset first beam group.

A quantity of beams in the first beam group is equal to a quantity of first CSI-RS signals, and all the first CSI-RS signals have a same beamforming factor.

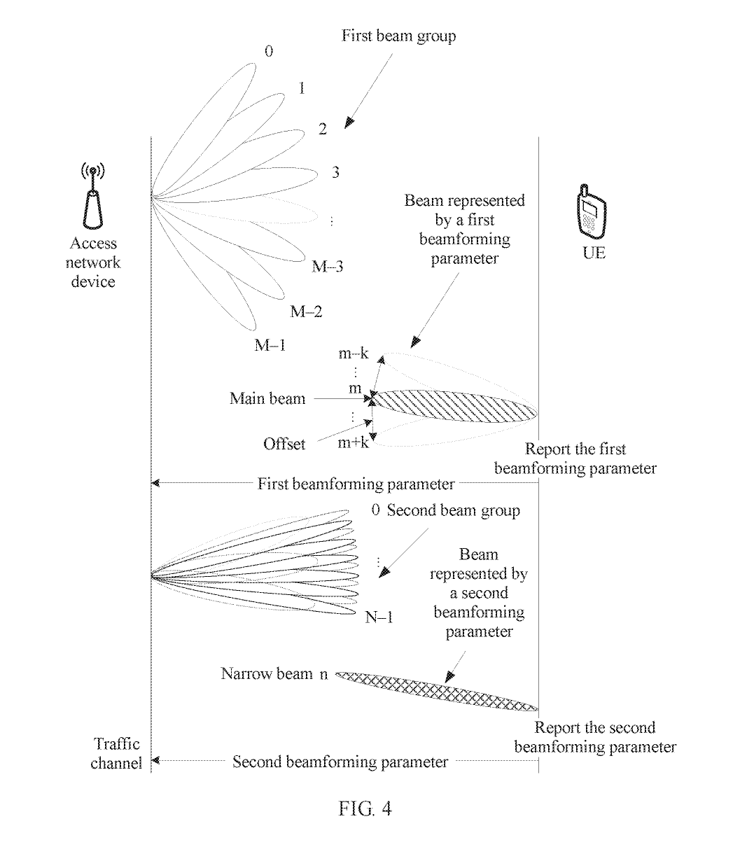

Specifically, when sending the CSI-RS signal at the first level to the UE, the access network device needs to perform beamforming on the to-be-sent CSI-RS signal at the first level, in other words, perform beamforming on the to-be-sent CSI-RS signal by using a beam in the preset first beam group. Each to-be-sent CSI-RS signal becomes the first CSI-RS signal after the beamforming, and all the first CSI-RS signals have the same beamforming factor. The access network device then sends all the first CSI-RS signals to the UE with reference to the quantity of CSI-RS signals to be sent at the first level. For ease of description, it is assumed that the first beam group includes M beams, and a width of each beam is P, as shown in a schematic diagram of feeding back a beamforming parameter in FIG. 4.

S203. The UE determines a first beamforming parameter based on the quantity of CSI-RS signals to be sent at the first level, a sampling rate at the first level, and the first CSI-RS signal.

S204. The UE reports the first beamforming parameter to the access network device.

A width of a beam represented by the first beamforming parameter is less than a width of the beam in the first beam group.

Specifically, after receiving the first CSI-RS signal sent by the access network device, the UE determines the first beamforming parameter with reference to the quantity of CSI-RS signals to be sent at the first level, the sampling rate at the first level, and all the first CSI-RS signals, and reports the first beamforming parameter to the access network device. The width of the beam represented by the determined first beamforming parameter is less than the width of the beam in the first beam group. Therefore, it may be learned that there is one beam width decrease process herein.

It should be noted that for a specific process of determining the first beamforming parameter, refer to the prior art. Details are not described herein.

Optionally, when reporting the first beamforming parameter, the UE may send the first beamforming parameter through a channel such as a downlink broadcast channel or a control channel. The first beamforming parameter may include an identifier i1,1 of a first main beam in a horizontal antenna direction, an identifier i1,2 of a second main beam in a vertical antenna direction, an offset Δi1,1 relative to the first main beam in the horizontal antenna direction, and an offset Δi1,1 relative to the second main beam in the vertical antenna direction. The first beamforming parameter may represent a group of beams, and a width (which is set to p) of each beam in the group of beams represented by the first beamforming parameter is less than the width P of the beam in the first beam group. As shown in FIG. 4, m in FIG. 4 is an identifier of a main beam (the first main beam or the second main beam), and k is an offset relative to the main beam.

S205. The access network device determines a second beam group based on the first beamforming parameter.

A width of a beam in the second beam group is less than or equal to the width of the beam represented by the first beamforming parameter, a quantity of beams in the second beam group is equal to a quantity of second CSI-RS signals, and all the second CSI-RS signals have a same beamforming factor.

Specifically, after receiving the first beamforming parameter reported by the UE, the access network device determines the second beam group based on the beam represented by the first beamforming parameter, in other words, the second beam group is related to the first beamforming parameter, and the width of the beam in the second beam group is less than or equal to the width of the beam represented by the first beamforming parameter. Therefore, when the width (which is set to Q) of the beam in the second beam group determined by the access network device is less than the width p of the beam represented by the first beamforming parameter, there is also one beam width decrease process herein.

S206. The access network device sends a second CSI-RS signal to the UE based on a quantity of CSI-RS signals to be sent at a second level and the second beam group.

Similarly, after the access network device determines the second beam group, the access network device performs beamforming on a to-be-sent CSI-RS signal at the second level by using a beam in the second beam group. Each to-be-sent CSI-RS signal becomes the second CSI-RS signal after the beamforming, and all the second CSI-RS signals have the same beamforming factor. The access network device then sends all the second CSI-RS signals to the UE with reference to the quantity of CSI-RS signals to be sent at the second level. For ease of description, it is assumed that the second beam group includes N beams, and a width of each beam is Q, as shown in the schematic diagram of feeding back a beamforming parameter in FIG. 4.

S207. The UE determines a second beamforming parameter based on the quantity of CSI-RS signals to be sent at the second level, a sampling rate at the second level, and the second CSI-RS signal.

A width of beamforming represented by the second beamforming parameter is less than the width of the beam in the second beam group.

S208. The UE sends the second beamforming parameter to the access network device.

Specifically, after receiving the second CSI-RS signal sent by the access network device, the UE determines the second beamforming parameter with reference to the quantity of CSI-RS signals to be sent at the second level, the sampling rate at the second level, and all the second CSI-RS signals, and reports the second beamforming parameter to the access network device. The width (which is set to q) of the beam represented by the determined second beamforming parameter is less than the width Q of the beam in the second beam group. Therefore, it may be learned that there is also one beam width decrease process herein.

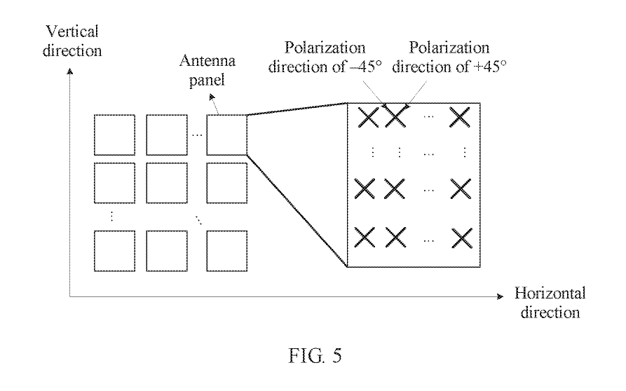

It should be noted that for a specific process of determining the second beamforming parameter, refer to the prior art. Details are not described herein. Optionally, when reporting the second beamforming parameter, the UE may send the second beamforming parameter through a downlink traffic channel. The second beamforming parameter may include an identifier i2,1 of a beam in the horizontal antenna direction, an identifier i2,2 of a beam in the vertical antenna direction, and a phase difference i2,c in two antenna polarization directions. The second beamforming parameter represents a narrow beam n, to be specific, the identifier of the beam in the horizontal antenna direction and the identifier of the beam in the vertical antenna direction are identifiers of the narrow beam, as shown in FIG. 4. Optionally, in a 5G mobile communications system, for an antenna model, refer to FIG. 5.

S209. The access network device performs downlink data transmission based on the second beamforming parameter.

It may be learned from the foregoing descriptions that in this embodiment of the present invention, “the width P of the beam in the first beam group”>“the width p of the beam represented by the first beamforming parameter”≥“the width Q of the beam in the second beam group”>“the width q of the beam represented by the second beamforming parameter”. To be specific, when the access network device delivers the CSI-RS signals at two levels, and the UE reports the beamforming parameters at two levels, there are a plurality of beam width decrease processes, so that the width of the beam represented by the second beamforming parameter finally reported by the UE to the access network device is far less than a width of a beam reported by UE to an access network device at a second level in the prior art, accuracy of a beam direction is greatly improved, and the beam is more directive. Therefore, when the access network device performs downlink data transmission, interference between neighboring cells can be obviously avoided, and average frequency efficiency of a cell and frequency efficiency of a cell-edge user are greatly improved.

According to the information transmission method provided in this embodiment of the present invention, the access network device sends, to the UE, the CSI-RS configuration parameter that includes a quantity of CSI-RS signals at each level and a sampling rate at each level, and then sends the first CSI-RS signal to the UE based on the quantity of CSI-RS signals to be sent at the first level and the preset first beam group, so that the UE determines the first beamforming parameter based on the quantity of CSI-RS signals to be sent at the first level, the sampling rate at the first level, and the first CSI-RS signal, and reports the first beamforming parameter to the access network device, and the access network device then determines the second beam group based on the first beamforming parameter, and sends the second CSI-RS signal to the UE based on the quantity of CSI-RS signals to be sent at the second level and the second beam group, so that the UE determines the second beamforming parameter based on the quantity of CSI-RS signals to be sent at the second level, the sampling rate at the second level, and the second CSI-RS signal, and reports the second beamforming parameter to the access network device. The UE may calculate an accurate beamforming parameter based on the CSI-RS configuration parameter and a CSI-RS signal delivered at each level, a width of a beam represented by a beamforming parameter at each level is less than a width of beamforming used for delivering a CSI-RS signal at each level, and a width of beamforming used for delivering a CSI-RS signal at a current level is less than or equal to a width of a beam represented by a beamforming parameter reported at a previous level. Therefore, there may be a plurality of beam width decrease processes in this embodiment of the present invention, so that the width of the beam represented by the beamforming parameter finally reported by the UE to the access network device is far less than the width of the beam reported by the UE to the access network device at the second level in the prior art, accuracy of the beam direction is greatly improved, and the beam is more directive. Therefore, when the access network device performs downlink data transmission, interference between neighboring cells can be obviously avoided, and average frequency efficiency of a cell and frequency efficiency of a cell-edge user are greatly improved.

Optionally, the CSI-RS configuration parameter may further include a CSI-RS send window parameter, the CSI-RS send window parameter is used to represent a sending manner of a CSI-RS signal at each level, and the sending manner includes at least one of the following manners: a manner in which the CSI-RS signal at each level is sent by using a time domain window, a manner in which the CSI-RS signal at each level is sent by using a frequency domain window, or a manner in which the CSI-RS signal at each level is sent by using both a time domain window and a frequency domain window. With reference to the embodiment shown in FIG. 3, the CSI-RS signal at the first level may be sent by using the time domain window, or may be sent by using the frequency domain window, and the CSI-RS signal at the second level may be sent by using the time domain window, or may be sent by using the frequency domain window. Optionally, the CSI-RS signals at the first level may be sent in a same sending manner or different sending manners.

In a possible implementation of this embodiment, the access network device may send the CSI-RS signal at the first level in the time domain window, and send the CSI-RS signal at the second level in the frequency domain window, in other words, the CSI-RS send window parameter includes a first send window parameter and a second send window parameter. The first send window parameter includes a start sending symbol or subframe Tstart of a CSI-RS signal in time domain, a symbol or subframe offset Toffset of the CSI-RS signal in time domain, and a total quantity Ttotal of symbols or subframes occupied by the CSI-RS signal in time domain, and is used to indicate, to the UE, that the access network device sends the CSI-RS signal at the first level by using the time domain window. The second send window parameter includes a start sending subcarrier, resource block, or sub-band Fstart of a CSI-RS signal in frequency domain, a subcarrier, resource block, or sub-band offset Foffset of the CSI-RS signal in frequency domain, and a total quantity Ftotal of subcarriers, resource blocks, or sub-bands occupied by the CSI-RS signal in frequency domain, and is used to indicate, to the UE, that the access network device sends the CSI-RS signal at the second level by using the frequency domain window.

For details, refer to a schematic diagram of sending a CSI-RS in FIG. 6. In FIG. 6, a CSI-RS signal at a first level is sent in a time domain window, and a sending period is relatively long. Because a beam used to perform beamforming on the CSI-RS signal at the first level is relatively wide, when all CSI-RS signals are sent in a time division manner, all transmit power may be concentrated on a beam corresponding to a CSI-RS signal for forming, and therefore coverage performance of the CSI-RS signal at the first level can be enhanced. In addition, in FIG. 6, CSI-RS signals at a second level are sent in a same subframe in a frequency division manner. In this manner, a channel change is small, and a sending period is relatively short. Because a beam used to perform beamforming on a CSI-RS signal at the second level is relatively narrow, forming gains in this manner are large. Therefore, each CSI-RS signal may occupy several subcarriers in the same subframe for sending, so that fast channel measurement can be implemented in one subframe, facilitating traffic channel sending, and improving a traffic channel transmission rate.

According to the information transmission method provided in this embodiment of the present invention, the access network device sends the CSI-RS signal at the first level in the time domain window, and sends the CSI-RS signal at the second level in the frequency domain window. Therefore, not only the coverage performance of the CSI-RS signal at the first level can be enhanced, but also a measurement rate of the CSI-RS signal at the second level can be accelerated, thereby improving channel measurement accuracy, and improving a traffic channel transmission rate.

Persons of ordinary skill in the art may understand that all or some of the steps of the method embodiments may be implemented by a program instructing related hardware. The program may be stored in a computer readable storage medium. When the program runs, the steps of the method embodiments are performed. The storage medium includes any medium that can store program code, such as a ROM, a RAM, a magnetic disk, or an optical disc.

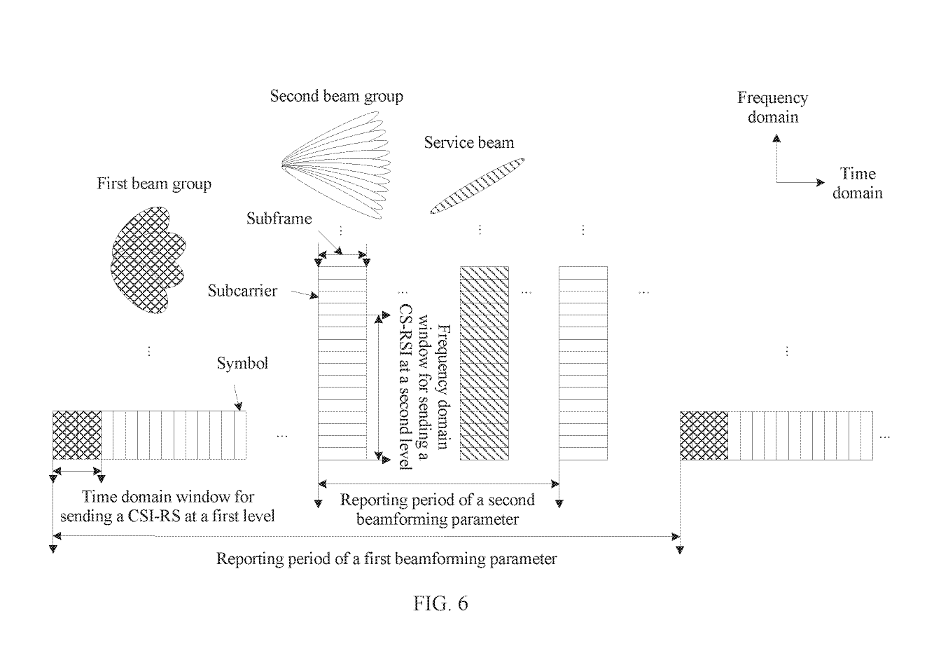

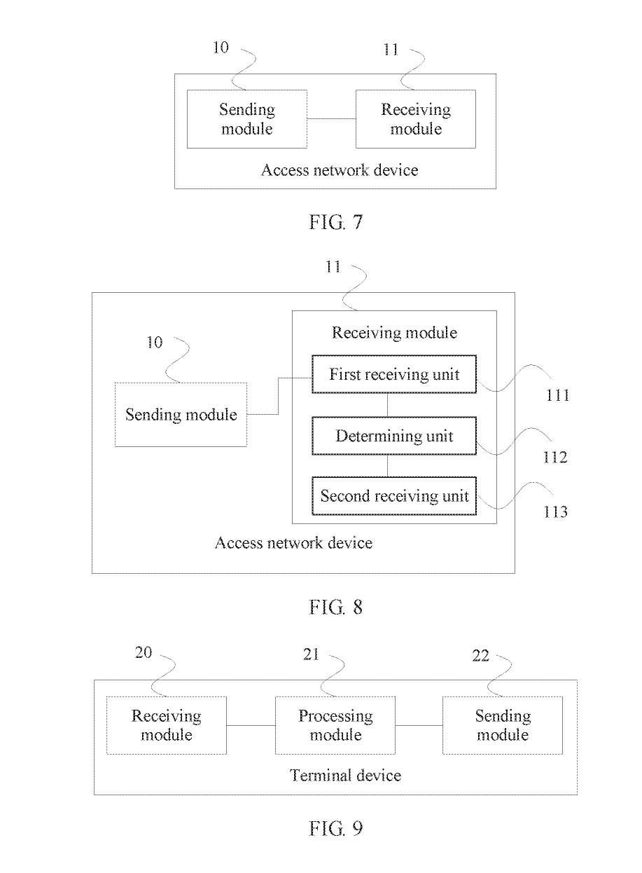

FIG. 7 is a schematic structural diagram of Embodiment 1 of an access network device according to an embodiment of the present invention. The access network device may execute the foregoing method embodiments. As shown in FIG. 7, the access network device may include a sending module 10 and a receiving module 11.

The sending module 10 is configured to send a channel state information-reference signal CSI-RS configuration parameter to a terminal device UE. The CSI-RS configuration parameter includes a quantity of CSI-RS signals to be sent by the access network device at each level and a sampling rate at each level.

The receiving module 11 is configured to: after the sending module 10 sends, based on the quantity of CSI-RS signals at each level, a CSI-RS signal corresponding to each level to the UE, receive a beamforming parameter at each level that is reported by the UE for the CSI-RS signal at each level. The beamforming parameter at each level is determined by the UE based on the CSI-RS signal at each level and the sampling rate at each level, a width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

The sending module 10 may be implemented by corresponding hardware or software, for example, may be implemented by a transmitter, a transmit antenna, or a transmitter chip. The receiving module 11 may be implemented by corresponding hardware or software, for example, may be implemented by a receiver, a receive antenna, or a receiver chip. This is not limited in this embodiment of the present invention.

The access network device provided in this embodiment of the present invention may execute the foregoing method embodiments, and an implementation principle and a technical effect thereof are similar. Details are not described herein.

Optionally, the quantity of CSI-RS signals to be sent at each level includes a quantity of CSI-RS signals that have a same polarization direction in a horizontal direction and a quantity of CSI-RS signals that have a same polarization direction in a vertical direction, and the sampling rate at each level includes a sampling rate in the horizontal direction and a sampling rate in the vertical direction.

Optionally, the CSI-RS configuration parameter further includes a CSI-RS send window parameter, the CSI-RS send window parameter is used to represent a sending manner of the CSI-RS signal at each level, and the sending manner includes at least one of the following manners: a manner in which the CSI-RS signal at each level is sent by using a time domain window, a manner in which the CSI-RS signal at each level is sent by using a frequency domain window, or a manner in which the CSI-RS signal at each level is sent by using both a time domain window and a frequency domain window

FIG. 8 is a schematic structural diagram of Embodiment 2 of an access network device according to an embodiment of the present invention. In this embodiment, the CSI-RS configuration parameter includes a quantity of CSI-RS signals to he sent by the access network device at a first level, a quantity of CSI-RSs to be sent at a second level, a sampling rate at the first level, and a sampling rate at the second level. Based on the foregoing embodiment, the receiving module 11 specifically includes a first receiving unit 111, a determining unit 112, and a second receiving unit 113.

The first receiving unit 111 is configured to: after the sending module 10 sends a first CSI-RS signal to the UE based on the quantity of CSI-RS signals to be sent at the first level and a preset first beam group, receive a first beamforming parameter reported by the UE based on the quantity of CSI-RS signals to be sent at the first level, the sampling rate at the first level, and the first CSI-RS signal. A width of a beam represented by the first beamforming parameter is less than a width of a beam in the first beam group, a quantity of beams in the first beam group is equal to a quantity of first CSI-RS signals, and all the first CSI-RS signals have a same beamforming factor.

The determining unit 112 is configured to determine a second beam group based on the first beamforming parameter.

The sending module 10 is further configured to send a second CSI-RS signal to the UE based on the quantity of CSI-RS signals to be sent at the second level and the second beam group. A width of a beam in the second beam group is less than or equal to the width of the beam represented by the first beamforming parameter, a quantity of beams in the second beam group is equal to a quantity of second CSI-RS signals, and all the second CSI-RS signals have a same beamforming factor.

The second receiving unit 113 is configured to receive a second beamforming parameter reported by the UE based on the quantity of CSI-RS signals to be sent at the second level, the sampling rate at the second level, and the second CSI-RS signal. A width of beamforming represented by the second beamforming parameter is less than the width of the beam in the second beam group.

Further, the first beamforming parameter includes an identifier of a first main beam in a horizontal antenna direction, an identifier of a second main beam in a vertical antenna direction, an offset relative to the first main beam in the horizontal antenna direction, and an offset relative to the second main beam in the vertical antenna direction; and

the second beamforming parameter includes an identifier of a beam in the horizontal antenna direction, an identifier of a beam in the vertical antenna direction, and a phase difference in two antenna polarization directions.

Optionally, the CSI-RS send window parameter includes a first send window parameter and a second send window parameter, and the first send window parameter includes a start sending symbol or subframe of a CSI-RS signal in time domain, a symbol or subframe offset of the CSI-RS signal in time domain, and a total quantity of symbols or subframes occupied by the CSI-RS signal in time domain, and is used to indicate, to the UE, that the access network device sends a CSI-RS signal at the first level by using the time domain window; and

the second send window parameter includes a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and is used to indicate, to the UE, that the access network device sends a CSI-RS signal at the second level by using the frequency domain window.

The access network device provided in this embodiment of the present invention may execute the foregoing method embodiments, and an implementation principle and a technical effect thereof are similar. Details are not described herein.

FIG. 9 is a schematic structural diagram of Embodiment 1 of a terminal device according to an embodiment of the present invention. As shown in FIG. 9, the terminal device includes a receiving module 20, a processing module 21, and a sending module 22.

Specifically, the receiving module 20 is configured to receive a channel state information-reference signal CSI-RS configuration parameter sent by an access network device. The CSI-RS configuration parameter includes a quantity of CSI-RS signals to be sent by the access network device at each level and a sampling rate at each level.

The processing module 21 is configured to: after the receiving module 20 receives a CSI-RS signal at each level that is sent by the access network device, determine a beamforming parameter at each level based on the CSI-RS signal at each level and the sampling rate at each level, and report the beamforming parameter at each level to the access network device by using the sending module 22. A width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

The sending module 22 may be implemented by corresponding hardware or software, for example, may be implemented by a transmitter, a transmit antenna, or a transmitter chip. The receiving module 20 may be implemented by corresponding hardware or software, for example, may be implemented by a receiver, a receive antenna, or a receiver chip. This is not limited in this embodiment of the present invention. The processing module 21 may be implemented by a corresponding processor or processing chip in the terminal device.

The terminal device provided in this embodiment of the present invention may execute the foregoing method embodiments, and an implementation principle and a technical effect thereof are similar. Details are not described herein.

Optionally, the quantity of CSI-RS signals to be sent at each level includes a quantity of CSI-RS signals that have a same polarization direction in a horizontal direction and a quantity of CSI-RS signals that have a same polarization direction in a vertical direction, and the sampling rate at each level includes a sampling rate in the horizontal direction and a sampling rate in the vertical direction.

Optionally, the CSI-RS configuration parameter further includes a CSI-RS send window parameter, the CSI-RS send window parameter is used to represent a sending manner of the CSI-RS signal at each level, and the sending manner includes at least one of the following manners: a manner in which the CSI-RS signal at each level is sent by using a time domain window, a manner in which the CSI-RS signal at each level is sent by using a frequency domain window, or a manner in which the CSI-RS signal at each level is sent by using both a time domain window and a frequency domain window.

FIG. 10 is a schematic structural diagram of Embodiment 2 of a terminal device according to an embodiment of the present invention. In this embodiment, the CSI-RS configuration parameter includes a quantity of CSI-RS signals to be sent by the access network device at a first level, a quantity of CSI-RSs to be sent at a second level, a sampling rate at the first level, and a sampling rate at the second level. Based on the foregoing embodiment, as shown in FIG. 10, the processing module 21 specifically includes a first processing unit 221 and a second processing unit 222.

The first processing unit 221 is configured to: after the receiving module 20 receives a first CSI-RS signal sent by the access network device based on the quantity of CSI-RS signals to be sent at the first level and a first beam group, determine a first beamforming parameter based on the quantity of CSI-RS signals to be sent at the first level, the sampling rate at the first level, and the first CSI-RS signal, and report the first beamforming parameter to the access network device by using the sending module 22. A width of a beam represented by the first beamforming parameter is less than a width of a beam in the first beam group, a quantity of beams in the first beam group is equal to a quantity of first CSI-RS signals, and all the first CSI-RS signals have a same beamforming factor.

The second processing unit 222 is configured to: after the receiving module 20 receives a second CSI-RS signal sent by the access network device based on the quantity of CSI-RS signals to be sent at the second level and a second beam group, determine a second beamforming parameter based on the quantity of CSI-RS signals to be sent at the second level, the sampling rate at the second level, and the second CSI-RS signal, and report the second beamforming parameter to the access network device by using the sending module 22. The second beam group is determined by the access network device based on the first beamforming parameter, a width of a beam in the second beam group is less than or equal to the width of the beam represented by the first beamforming parameter, a quantity of beams in the second beam group is equal to a quantity of second CSI-RS signals, all the second CSI-RS signals have a same beamforming factor, and a width of beamforming represented by the second beamforming parameter is less than the width of the beam in the second beam group.

Further, the first beamforming parameter includes an identifier of a first main beam in a horizontal antenna direction, an identifier of a second main beam in a vertical antenna direction, an offset relative to the first main beam in the horizontal antenna direction, and an offset relative to the second main beam in the vertical antenna direction; and

the second beamforming parameter includes an identifier of a beam in the horizontal antenna direction, an identifier of a beam in the vertical antenna direction, and a phase difference in two antenna polarization directions.

Optionally, the CSI-RS send window parameter includes a first send window parameter and a second send window parameter, and the first send window parameter includes a start sending symbol or subframe of a CSI-RS signal in time domain, a symbol or subframe offset of the CSI-RS signal in time domain, and a total quantity of symbols or subframes occupied by the CSI-RS signal in time domain, and is used to indicate, to the UE, that the access network device sends a CSI-RS signal at the first level by using the time domain window; and

the second send window parameter includes a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and is used to indicate, to the UE, that the access network device sends a CSI-RS signal at the second level by using the frequency domain window.

The terminal device provided in this embodiment of the present invention may execute the foregoing method embodiments, and an implementation principle and a technical effect thereof are similar. Details are not described herein.

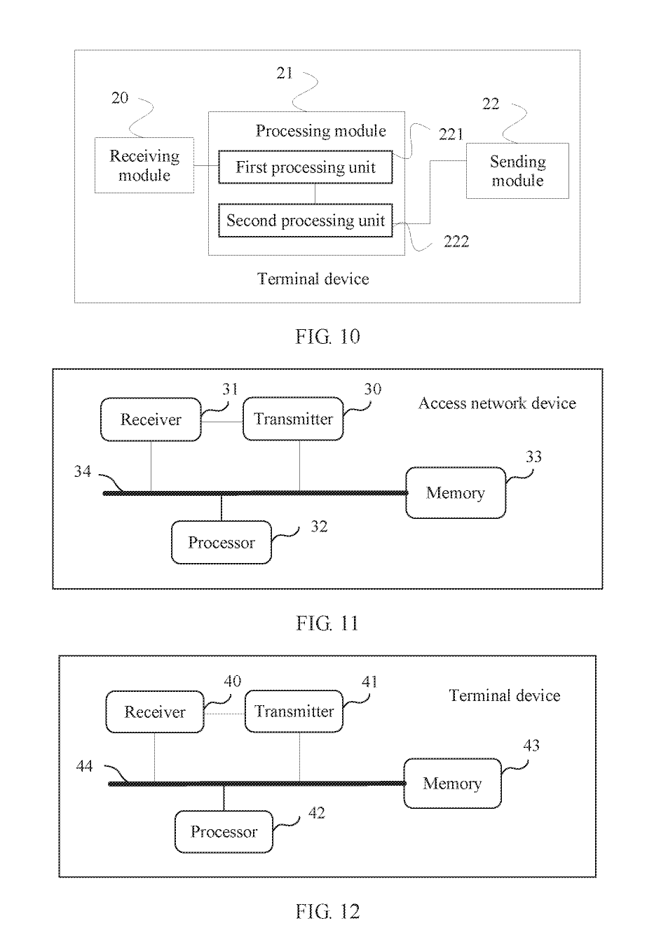

FIG. 11 is a schematic structural diagram of Embodiment 3 of an access network device according to an embodiment of the present invention. As shown in FIG. 11, the access network device may include a transmitter 30, a receiver 31, a processor 32, a memory 33, and at least one communications bus 34. The communications bus 34 is configured to implement a communication connection between components. The memory 33 may include a high-speed RAM memory, and may further include a nonvolatile memory NVM, for example, at least one magnetic disk memory. The memory 33 may store various programs, to complete various processing functions and implement the method steps in the embodiments. Optionally, the receiver 31 in this embodiment may be a radio frequency module or a baseband module in the access network device, and the transmitter 30 in this embodiment may also be the radio frequency module or the baseband module in the access network device. Optionally, the transmitter 30 and the receiver 31 may be integrated into a transceiver.

In this embodiment, the transmitter 30 is configured to send a channel state information-reference signal CSI-RS configuration parameter to a terminal device UE. The CSI-RS configuration parameter includes a quantity of CSI-RS signals to be sent by the access network device at each level and a sampling rate at each level.

The receiver 31 is configured to: after the transmitter 30 sends, based on the quantity of CSI-RS signals at each level, a CSI-RS signal corresponding to each level to the UE, receive a beamforming parameter at each level that is reported by the UE for the CSI-RS signal at each level. The beamforming parameter at each level is determined by the UE based on the CSI-RS signal at each level and the sampling rate at each level, a width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

Optionally, the quantity of CSI-RS signals to be sent at each level includes a quantity of CSI-RS signals that have a same polarization direction in a horizontal direction and a quantity of CSI-RS signals that have a same polarization direction in a vertical direction, and the sampling rate at each level includes a sampling rate in the horizontal direction and a sampling rate in the vertical direction.

Optionally, the CSI-RS configuration parameter further includes a CSI-RS send window parameter, the CSI-RS send window parameter is used to represent a sending manner of the CSI-RS signal at each level, and the sending manner includes at least one of the following manners: a manner in which the CSI-RS signal at each level is sent by using a time domain window, a manner in which the CSI-RS signal at each level is sent by using a frequency domain window, or a manner in which the CSI-RS signal at each level is sent by using both a time domain window and a frequency domain window.

Optionally, the CSI-RS configuration parameter includes a quantity of CSI-RS signals to be sent by the access network device at a first level, a quantity of CSI-RSs to be sent at a second level, a sampling rate at the first level, and a sampling rate at the second level.

The receiver 31 is specifically configured to: after the transmitter 30 sends a first CSI-RS signal to the UE based on the quantity of CSI-RS signals to be sent at the first level and a preset first beam group, receive a first beamforming parameter reported by the UE based on the quantity of CSI-RS signals to be sent at the first level, the sampling rate at the first level, and the first CSI-RS signal. A width of a beam represented by the first beamforming parameter is less than a width of a beam in the first beam group, a quantity of beams in the first beam group is equal to a quantity of first CSI-RS signals, and all the first CSI-RS signals have a same beamforming factor.

The transmitter 30 is configured to send a second CSI-RS signal to the UE based on the quantity of CSI-RS signals to be sent at the second level and a second beam group determined by the processor 32 with reference to the first beamforming parameter. A width of a beam in the second beam group is less than or equal to the width of the beam represented by the first beamforming parameter, a quantity of beams in the second beam group is equal to a quantity of second CSI-RS signals, and all the second CSI-RS signals have a same beamforming factor.

The receiver 31 is further configured to receive a second beamforming parameter reported by the UE based on the quantity of CSI-RS signals to be sent at the second level, the sampling rate at the second level, and the second CSI-RS signal. A width of beamforming represented by the second beamforming parameter is less than the width of the beam in the second beam group.

Further, the first beamforming parameter includes an identifier of a first main beam in a horizontal antenna direction, an identifier of a second main beam in a vertical antenna direction, an offset relative to the first main beam in the horizontal antenna direction, and an offset relative to the second main beam in the vertical antenna direction; and

the second beamforming parameter includes an identifier of a beam in the horizontal antenna direction, an identifier of a beam in the vertical antenna direction, and a phase difference in two antenna polarization directions.

Optionally, the CSI-RS send window parameter includes a first send window parameter and a second send window parameter, and the first send window parameter includes a start sending symbol or subframe of a CSI-RS signal in time domain, a symbol or subframe offset of the CSI-RS signal in time domain, and a total quantity of symbols or subframes occupied by the CSI-RS signal in time domain, and is used to indicate, to the UE, that the access network device sends a CSI-RS signal at the first level by using the time domain window; and

the second send window parameter includes a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and is used to indicate, to the UE, that the access network device sends a CSI-RS signal at the second level by using the frequency domain window.

The access network device provided in this embodiment of the present invention may execute the foregoing method embodiments, and an implementation principle and a technical effect thereof are similar. Details are not described herein.

FIG. 12 is a schematic structural diagram of Embodiment 3 of a terminal device according to an embodiment of the present invention. As shown in FIG. 12, the terminal device may include a receiver 40, a transmitter 41, a processor 42, a memory 43, and at least one communications bus 44. The communications bus 44 is configured to implement a communication connection between components. The memory 43 may include a high-speed RAM memory, and may further include a nonvolatile memory NVM, for example, at least one magnetic disk memory. The memory 43 may store various programs, to complete various processing functions and implement the method steps in the embodiments. Optionally, the receiver 40 in this embodiment may be a radio frequency module or a baseband module in the access network device, and the transmitter 41 in this embodiment may also be the radio frequency module or the baseband module in the access network device. Optionally, the transmitter 41 and the receiver 40 may be integrated into a transceiver.

In this embodiment, the receiver 40 is configured to receive a channel state information-reference signal CSI-RS configuration parameter sent by an access network device. The CSI-RS configuration parameter includes a quantity of CSI-RS signals to be sent by the access network device at each level and a sampling rate at each level.

The processor 42 is configured to: after the receiver 40 receives a CSI-RS signal at each level that is sent by the access network device, determine a beamforming parameter at each level based on the CSI-RS signal at each level and the sampling rate at each level, and report the beamforming parameter at each level to the access network device by using the transmitter 41. A width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

Optionally, the quantity of CSI-RS signals to be sent at each level includes a quantity of CSI-RS signals that have a same polarization direction in a horizontal direction and a quantity of CSI-RS signals that have a same polarization direction in a vertical direction, and the sampling rate at each level includes a sampling rate in the horizontal direction and a sampling rate in the vertical direction.

Optionally, the CSI-RS configuration parameter further includes a CSI-RS send window parameter, the CSI-RS send window parameter is used to represent a sending manner of the CSI-RS signal at each level, and the sending manner includes at least one of the following manners: a manner in which the CSI-RS signal at each level is sent by using a time domain window, a manner in which the CSI-RS signal at each level is sent by using a frequency domain window, or a manner in which the CSI-RS signal at each level is sent by using both a time domain window and a frequency domain window.

Optionally, the CSI-RS configuration parameter includes a quantity of CSI-RS signals to be sent by the access network device at a first level, a quantity of CSI-RSs to be sent at a second level, a sampling rate at the first level, and a sampling rate at the second level.

The processor 42 is specifically configured to: after the receiver 40 receives a first CSI-RS signal sent by the access network device based on the quantity of CSI-RS signals to be sent at the first level and a first beam group, determine a first beamforming parameter based on the quantity of CSI-RS signals to be sent at the first level, the sampling rate at the first level, and the first CSI-RS signal, and report the first beamforming parameter to the access network device by using the transmitter 41. A width of a beam represented by the first beamforming parameter is less than a width of a beam in the first beam group, a quantity of beams in the first beam group is equal to a quantity of first CSI-RS signals, and all the first CSI-RS signals have a same beamforming factor.

The processor 42 is further configured to: after the receiver 40 receives a second CSI-RS signal sent by the access network device based on the quantity of CSI-RS signals to be sent at the second level and a second beam group, determine a second beamforming parameter based on the quantity of CSI-RS signals to be sent at the second level, the sampling rate at the second level, and the second CSI-RS signal, and report the second beamforming parameter to the access network device by using the transmitter 41. The second beam group is determined by the access network device based on the first beamforming parameter, a width of a beam in the second beam group is less than or equal to the width of the beam represented by the first beamforming parameter, a quantity of beams in the second beam group is equal to a quantity of second CSI-RS signals, all the second CSI-RS signals have a same beamforming factor, and a width of beamforming represented by the second beamforming parameter is less than the width of the beam in the second beam group.

Further, the first beamforming parameter includes an identifier of a first main beam in a horizontal antenna direction, an identifier of a second main beam in a vertical antenna direction, an offset relative to the first main beam in the horizontal antenna direction, and an offset relative to the second main beam in the vertical antenna direction; and

the second beamforming parameter includes an identifier of a beam in the horizontal antenna direction, an identifier of a beam in the vertical antenna direction, and a phase difference in two antenna polarization directions.

Optionally, the CSI-RS send window parameter includes a first send window parameter and a second send window parameter, and the first send window parameter includes a start sending symbol or subframe of a CSI-RS signal in time domain, a symbol or subframe offset of the CSI-RS signal in time domain, and a total quantity of symbols or subframes occupied by the CSI-RS signal in time domain, and is used to indicate, to the UE, that the access network device sends a CSI-RS signal at the first level by using the time domain window; and

the second send window parameter includes a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and is used to indicate, to the UE, that the access network device sends a CSI-RS signal at the second level by using the frequency domain window.

The terminal device provided in this embodiment of the present invention may execute the foregoing method embodiments, and an implementation principle and a technical effect thereof are similar. Details are not described herein.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. An information transmission method, implemented by an access network device, wherein the information transmission method comprises:
sending a channel state information-reference signal (CSI-RS) configuration parameter to a user equipment (UE), wherein the CSI-RS configuration parameter comprises a quantity of CSI-RS signals to be sent by the access network device at each level and a sampling rate at each level;
sending, based on the quantity of CSI-RS signals at each level, a CSI-RS signal corresponding to each level to the UE; and
receiving a beamforming parameter at each level that is reported by the UE for the CSI-RS signal at each level, wherein the beamforming parameter at each level is determined by the UE based on the CSI-RS signal at each level and the sampling rate at each level, wherein a width of a beam represented by the beamforming parameter at each level is less than a width of beamforming used for delivering the CSI-RS signal at each level, and wherein a width of beamforming used for delivering a CSI-RS signal at a current level is less than or equal to a width of a beam represented by a beamforming parameter reported at a previous level.

2. The information transmission method of claim 1, wherein the quantity of CSI-RS signals to be sent at each level comprises a quantity of CSI-RS signals that have a same polarization direction in a horizontal direction and a quantity of CSI-RS signals that have a same polarization direction in a vertical direction, and wherein the sampling rate at each level comprises a sampling rate in the horizontal direction and a sampling rate in the vertical direction.

3. The information transmission method of claim 1, wherein the CSI-RS configuration parameter further comprises a CSI-RS send window parameter, wherein the CSI-RS send window parameter represents a sending manner of the CSI-RS signal at each level, and wherein the sending manner comprises at least one of a manner in which the CSI-RS signal at each level is sent using a time domain window, a manner in which the CSI-RS signal at each level is sent using a frequency domain window, or a manner in which the CSI-RS signal at each level is sent using both a time domain window and a frequency domain window.

4. The information transmission method of claim 3, wherein the CSI-RS configuration parameter comprises a quantity of CSI-RS signals to be sent by the access network device at a first level, a quantity of CSI-RS signals to be sent at a second level, a sampling rate at the first level, and a sampling rate at the second level, and wherein receiving the beamforming parameter at each level that is reported by the UE for the CSI-RS signal at each level comprises:
receiving a first beamforming parameter reported by the UE based on the quantity of CSI-RS signals to be sent at the first level, the sampling rate at the first level, and a first CSI-RS signal after sending the first CSI-RS signal to the UE based on the quantity of CSI-RS signals to be sent at the first level and a first beam group, wherein a width of a beam represented by the first beamforming parameter is less than a width of a beam in the first beam group, wherein a quantity of beams in the first beam group is equal to a quantity of first CSI-RS signals, and wherein all the first CSI-RS signals have a same beamforming factor;
determining a second beam group based on the first beamforming parameter;
sending a second CSI-RS signal to the UE based on the quantity of CSI-RS signals to be sent at the second level and the second beam group, wherein a width of a beam in the second beam group is less than or equal to the width of the beam represented by the first beamforming parameter, wherein a quantity of beams in the second beam group is equal to a quantity of second CSI-RS signals, and wherein all the second CSI-RS signals have a same beamforming factor; and
receiving a second beamforming parameter reported by the UE based on the quantity of CSI-RS signals to be sent at the second level, the sampling rate at the second level, and the second CSI-RS signal, wherein a width of beamforming represented by the second beamforming parameter is less than the width of the beam in the second beam group.

5. The information transmission method of claim 4, wherein the first beamforming parameter comprises an identifier of a first main beam in a horizontal antenna direction, an identifier of a second main beam in a vertical antenna direction, an offset relative to the first main beam in the horizontal antenna direction, and an offset relative to the second main beam in the vertical antenna direction, and wherein the second beamforming parameter comprises an identifier of a beam in the horizontal antenna direction, an identifier of a beam in the vertical antenna direction, and a phase difference in two antenna polarization directions.

6. The information transmission method of claim 4, wherein the CSI-RS send window parameter comprises a first send window parameter and a second send window parameter, wherein the first send window parameter comprises a start sending symbol or subframe of a CSI-RS signal in time domain, a symbol or subframe offset of the CSI-RS signal in time domain, and a total quantity of symbols or subframes occupied by the CSI-RS signal in time domain, wherein the first send window parameter indicates to the UE that the access network device sends a CSI-RS signal at the first level using the time domain window, wherein the second send window parameter comprises a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and wherein the second send window parameter indicates to the UE that the access network device sends a CSI-RS signal at the second level using the frequency domain window.

7.-24. (canceled)

25. An access network device, comprising:
a transmitter configured to:
send a channel state information-reference signal (CSI-RS) configuration parameter to a user equipment (UE), wherein the CSI-RS configuration parameter comprises a quantity of CSI-RS signals to be sent by the access network device at each level and a sampling rate at each level; and
send, based on the quantity of CSI-RS signals at each level, a CSI-RS signal corresponding to each level to the UE; and
a receiver configured to receive a beamforming parameter at each level that is reported by the UE for the CSI-RS signal at each level, wherein the beamforming parameter at each level is determined by the UE based on the CSI-RS signal at each level and the sampling rate at each level, wherein a width of a beam represented by the beamforming parameter at each level is less than a width of beamforming used for delivering the CSI-RS signal at each level, and wherein a width of beamforming used for delivering a CSI-RS signal at a current level is less than or equal to a width of a beam represented by a beamforming parameter reported at a previous level.

26. The access network device of claim 25, wherein the quantity of CSI-RS signals to be sent at each level comprises a quantity of CSI-RS signals that have a same polarization direction in a horizontal direction and a quantity of CSI-RS signals that have a same polarization direction in a vertical direction, and wherein the sampling rate at each level comprises a sampling rate in the horizontal direction and a sampling rate in the vertical direction.

27. The access network device of claim 25, wherein the CSI-RS configuration parameter further comprises a CSI-RS send window parameter, wherein the CSI-RS send window parameter represents a sending manner of the CSI-RS signal at each level, and wherein the sending manner comprises at least one of a manner in which the CSI-RS signal at each level is sent using a time domain window, a manner in which the CSI-RS signal at each level is sent using a frequency domain window, or a manner in which the CSI-RS signal at each level is sent using both a time domain window and a frequency domain window.

28. The access network device of claim 27, wherein the CSI-RS configuration parameter comprises a quantity of CSI-RS signals to be sent by the access network device at a first level, a quantity of CSI-RSs to be sent at a second level, a sampling rate at the first level, and a sampling rate at the second level, wherein the receiver is configured to receive a first beamforming parameter reported by the UE based on the quantity of CSI-RS signals to be sent at the first level, the sampling rate at the first level, and a first CSI-RS signal after the transmitter sends a first CSI-RS signal to the UE based on the quantity of CSI-RS signals to be sent at the first level and a first beam group, wherein a width of a beam represented by the first beamforming parameter is less than a width of a beam in the first beam group, wherein a quantity of beams in the first beam group is equal to a quantity of first CSI-RS signals, wherein all the first CSI-RS signals have a same beamforming factor, wherein the transmitter is configured to send a second CSI-RS signal to the UE based on the quantity of CSI-RS signals to be sent at the second level and a second beam group determined with reference to the first beamforming parameter, wherein a width of a beam in the second beam group is less than or equal to the width of the beam represented by the first beamforming parameter, wherein a quantity of beams in the second beam group is equal to a quantity of second CSI-RS signals, wherein all the second CSI-RS signals have a same beamforming factor, wherein the receiver is further configured to receive a second beamforming parameter reported by the UE based on the quantity of CSI-RS signals to be sent at the second level, the sampling rate at the second level, and the second CSI-RS signal, and wherein a width of beamforming represented by the second beamforming parameter is less than the width of the beam in the second beam group.

29. The access network device of claim 28, wherein the first beamforming parameter comprises an identifier of a first main beam in a horizontal antenna direction, an identifier of a second main beam in a vertical antenna direction, an offset relative to the first main beam in the horizontal antenna direction, and an offset relative to the second main beam in the vertical antenna direction, and wherein the second beamforming parameter comprises an identifier of a beam in the horizontal antenna direction, an identifier of a beam in the vertical antenna direction, and a phase difference in two antenna polarization directions.

30. The access network device of claim 28, wherein the CSI-RS send window parameter comprises a first send window parameter and a second send window parameter, wherein the first send window parameter comprises a start sending symbol or subframe of a CSI-RS signal in time domain, a symbol or subframe offset of the CSI-RS signal in time domain, and a total quantity of symbols or subframes occupied by the CSI-RS signal in time domain, wherein the first send window parameter indicates to the UE that the access network device sends a CSI-RS signal at the first level using the time domain window, wherein the second send window parameter comprises a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and wherein the second send window parameter indicates to the UE that the access network device sends a CSI-RS signal at the second level using the frequency domain window.

31. A terminal device, comprising:
a receiver configured to:
receive a channel state information-reference signal (CSI-RS) configuration parameter sent by an access network device, wherein the CSI-RS configuration parameter comprises a quantity of CSI-RS signals to be sent by the access network device at each level and a sampling rate at each level; and
receive a CSI-RS signal at each level that is sent by the access network device; and
a processor coupled to the receiver and configured to:
determine a beamforming parameter at each level based on the CSI-RS signal at each level and the sampling rate at each level; and
report the beamforming parameter at each level to the access network device, wherein a width of a beam represented by the beamforming parameter at each level is less than a width of beamforming used for delivering the CSI-RS signal at each level, and a width of beamforming used for delivering a CSI-RS signal at a current level is less than or equal to a width of a beam represented by a beamforming parameter reported at a previous level.

32. The terminal device of claim 31, wherein the quantity of CSI-RS signals to be sent at each level comprises a quantity of CSI-RS signals that have a same polarization direction in a horizontal direction and a quantity of CSI-RS signals that have a same polarization direction in a vertical direction, and wherein the sampling rate at each level comprises a sampling rate in the horizontal direction and a sampling rate in the vertical direction.

33. The terminal device of claim 31, wherein the CSI-RS configuration parameter further comprises a CSI-RS send window parameter, wherein the CSI-RS send window parameter represents a sending manner of the CSI-RS signal at each level, wherein the sending manner comprises at least one of a manner in which the CSI-RS signal at each level is sent using a time domain window, a manner in which the CSI-RS signal at each level is sent using a frequency domain window, or a manner in which the CSI-RS signal at each level is sent using both a time domain window and a frequency domain window.

34. The terminal device of claim 33, wherein the CSI-RS configuration parameter comprises a quantity of CSI-RS signals to be sent by the access network device at a first level, a quantity of CSI-RSs to be sent at a second level, a sampling rate at the first level, and a sampling rate at the second level, and wherein the processor is further configured to:
determine a first beamforming parameter based on the quantity of CSI-RS signals to be sent at the first level, the sampling rate at the first level, and a first CSI-RS signal after the receiver receives the first CSI-RS signal sent by the access network device based on the quantity of CSI-RS signals to be sent at the first level and a first beam group; and
report the first beamforming parameter to the access network device, wherein a width of a beam represented by the first beamforming parameter is less than a width of a beam in the first beam group, wherein a quantity of beams in the first beam group is equal to a quantity of first CSI-RS signals, wherein all the first CSI-RS signals have a same beamforming factor;
determine a second beamforming parameter based on the quantity of CSI-RS signals to be sent at the second level, the sampling rate at the second level, and a second CSI-RS signal after the receiver receives the second CSI-RS signal sent by the access network device based on the quantity of CSI-RS signals to be sent at the second level and a second beam group; and
report the second beamforming parameter to the access network device, wherein the second beam group is determined by the access network device based on the first beamforming parameter, wherein a width of a beam in the second beam group is less than or equal to the width of the beam represented by the first beamforming parameter, wherein a quantity of beams in the second beam group is equal to a quantity of second CSI-RS signals, wherein all the second CSI-RS signals have a same beamforming factor, and wherein a width of beamforming represented by the second beamforming parameter is less than the width of the beam in the second beam group.

35. The terminal device of claim 34, wherein the first beamforming parameter comprises an identifier of a first main beam in a horizontal antenna direction, an identifier of a second main beam in a vertical antenna direction, an offset relative to the first main beam in the horizontal antenna direction, and an offset relative to the second main beam in the vertical antenna direction, and wherein the second beamforming parameter comprises an identifier of a beam in the horizontal antenna direction, an identifier of a beam in the vertical antenna direction, and a phase difference in two antenna polarization directions.

36. The terminal device of claim 34, wherein the CSI-RS send window parameter comprises a first send window parameter and a second send window parameter, wherein the first send window parameter comprises a start sending symbol or subframe of a CSI-RS signal in time domain, a symbol or subframe offset of the CSI-RS signal in time domain, and a total quantity of symbols or subframes occupied by the CSI-RS signal in time domain, wherein the first send window parameter indicates to the UE that the access network device sends a CSI-RS signal at the first level using the time domain window, wherein the second send window parameter comprises a start sending subcarrier, resource block, or sub-band of a CSI-RS signal in frequency domain, a subcarrier, resource block, or sub-band offset of the CSI-RS signal in frequency domain, and a total quantity of subcarriers, resource blocks, or sub-bands occupied by the CSI-RS signal in frequency domain, and wherein the second send window parameter indicates to the UE that the access network device sends a CSI-RS signal at the second level using the frequency domain window.

37. The information transmission method of claim 2, wherein the CSI-RS configuration parameter further comprises a CSI-RS send window parameter, wherein the CSI-RS send window parameter represents a sending manner of the CSI-RS signal at each level, and wherein the sending manner comprises at least one of a manner in which the CSI-RS signal at each level is sent using a time domain window, a manner in which the CSI-RS signal at each level is sent using a frequency domain window, or a manner in which the CSI-RS signal at each level is sent using both a time domain window and a frequency domain window.

38. The access network device of claim 26, wherein the CSI-RS configuration parameter further comprises a CSI-RS send window parameter, wherein the CSI-RS send window parameter represents a sending manner of the CSI-RS signal at each level, and wherein the sending manner comprises at least one of a manner in which the CSI-RS signal at each level is sent using a time domain window, a manner in which the CSI-RS signal at each level is sent using a frequency domain window, or a manner in which the CSI-RS signal at each level is sent using both a time domain window and a frequency domain window.
